(19) United States
(12) Patent Application Publication
(10) Pub. No.: US 2010/0256008 A1
(43) Pub. Date: Oct. 7, 2010

(54) ENHANCER SIGNATURES IN THE PROGNOSIS AND DIAGNOSIS OF CANCERS AND OTHER DISORDERS

(76) Inventors: Bing Ren, San Diego, CA (US); Nathaniel David Heintzman, San Diego, CA (US); Raymond David Hawkins, San Diego, CA (US); Gary Chung Hon, San Diego, CA (US)

Correspondence Address: WHITE & CASE LLP;PATENT DEPARTMENT, 1155 AVENUE OF THE AMERICAS, NEW YORK, NY, 10036, US

(21) Appl. No.: 12/734,302

(22) PCT Filed: Oct. 24, 2008
(86) PCT No.: PCT/US2008/012086

§ 371 Date: Apr. 23, 2010

Related U.S. Application Data
(60) Provisional application No. 60/982,845, filed on Oct. 26, 2007.

(51) Int. Cl. C40B 30/04

(52) U.S. Cl. 506/9

(57) ABSTRACT

It has been discovered that enhancer signatures distinguish enhancer elements from other regulatory elements and that the characteristic enhancer signatures vary in a cell-type specific manner. These discoveries provide the basis for novel methods of predicting, diagnosing and monitoring of diseases, particularly cancer.

This application claims the benefit of U.S. Provisional Application No. 60/982,845, filed Oct. 26, 2007.

### BACKGROUND OF THE INVENTION

Temporal and tissue-specific gene expression in mammals depends on the cis-regulatory elements in the genome. These non-coding sequences can be divided into many classes depending on their regulatory functions [1]. Among the better-characterized elements are promoters, enhancers, silencers, and insulators. Transcription initiates from promoters, which serve as anchor points for the recruitment of the general transcriptional machinery [2,3]. Enhancers act to recruit a complex array of transcription factors and chromatin-modifying activities that facilitate gene transcription [4,5]. Repressor elements, on the other hand, bind proteins and/or modify chromatin structure to inhibit gene transcription [4,6]. Insulator elements provide additional regulation by preventing the spread of heterochromatin and restricting transcriptional enhancers from activating unrelated promoters [7]. Besides these four classes of cis-regulatory sequences, there are also locus control regions that facilitate the activation of a cluster of genes through still poorly understood mechanisms. A recent comprehensive survey of 1% of the human genome, using a combination of multiple genomic and computational methods, has identified a large number of transcripts and potential regulatory elements. However, it remains to be resolved how each class of regulatory element contributes to cell-type specific gene expression [8].

While all types of cis-regulatory elements can contribute to the cell-type specific gene expression program, recent studies have mainly focused on the role of promoters as a driving force behind tissue-specific and differential expression. These studies have revealed that many promoters contain transcription factor binding motifs for tissue-specific factors [9,10]. Indeed, some experimental evidence indicates that promoters are capable of directing certain degrees of cell-type specific expression in transient transfection assays [11]. However, it remains unclear to what extent promoters play a role in differential gene expression. On the other hand, it has long been recognized that enhancers are critical for the proper temporal and spatial expression from the gene promoter [12,13]. While the complex interplay between promoters and enhancers can occur across great distances in the genome [14,15], many enhancers have been shown to be within “close” proximity of the target promoter [13,16,17,18]. A number of studies have provided various means by which enhancers can regulate expression levels, including frequency of promoter-enhancer interaction, length of interactions [13,19], as well as strength of transcription factor binding [20,21,22].

Whether an enhancer is distal or proximal, how it determines its target promoter is unclear. One means of modulating which interactions occur is through insulator elements in the genome that act as enhancer-blockers and prevent such communication by separating enhancers from neighboring promoters [23,24,25]. Additionally, many insulator elements are thought to define blocks in which promoter-enhancer interactions can occur. Promoters and enhancers within these blocks are likely brought within close proximity to one another through chromatin looping [26]. The chromatin is organized into loops via insulator-insulator interactions or by localization to structures such as the nuclear envelope [26,27,28,29]. In this manner, insulators play a critical role in defining promoter-enhancer interactions.

In order to understand the roles of promoters, enhancers, and insulators in cell-type specific gene expression, we have systematically characterized the binding of general transcription factors, the insulator binding protein CTCF and several active chromatin modifications in 1% of the human genome in five diverse cell types. We have previously mapped chromatin modification profiles in the ENCODE regions in HeLa cells, and demonstrated that chromatin signatures are predictive of both promoters and enhancers [30]. Here, we generated maps of active promoters and enhancers, along with the insulator binding protein CTCF, in four additional cell types, including the leukemia cell line K562, immortalized lymphoblasts GM06690 (GM), undifferentiated human embryonic stem cells (ES) and BMP4-induced differentiated ES (dES). We show that the pattern of CTCF binding across all five cell types is remarkably similar, and that chromatin modifications at promoters are also largely invariant. In contrast, chromatin modifications at enhancers are highly dynamic across cell types. We also observe that differential gene expression correlates with differential enrichment of chromatin at promoters, as well as with changes in enhancer numbers. These results indicate that enhancers play an important role in cell-type dependent gene expression, and highlight the importance of identifying these sequences for understanding mechanisms of cell-type specific gene expression.

### BRIEF SUMMARY OF THE INVENTION

The invention is based on the discovery that characteristic chromatin signatures are associated with enhancers and, further, that within the genus of characteristic chromatin signatures associated with enhancers, the signatures differ in a cell-type specific way.

One embodiment of the invention is concerned with the general identification of enhancers based on the characteristic chromatin modifications found to be associated with this class of regulatory element. Another embodiment is concerned with the identification of differentially active and inactive genes based on the presence and distribution of enhancers. A third embodiment involves the monitoring, diagnosis and/or prognosis of diseases based on the presence and distribution of enhancer signatures associated with particular cell types and levels of expression of gene products within the cell types.

### BRIEF DESCRIPTION OF THE DRAWINGS

FIGS. 1a and b show the results of ChIP-chip analysis of the amounts of several different chromatin modifications including acetylated and methylated histones in selected promoters and enhancers.

FIG. 2 shows the results of computational clustering analysis of chromatin modifications at the transcriptional start sites (TSS's) across 5 cell types.

FIG. 3 shows the results of computational clustering and ChIP-chip analysis of the enrichment patterns of CTCF binding in 1% of the human genome across six cell types.

FIG. 4 shows the results of k-means clustering analysis of the enrichment patterns of chromatin modification in various p300 binding sites.

FIG. 5 shows the results of analysis of chromatin modification patterns of predicted enhancers across five cell types.

FIGS. 6a-c show plots of differential gene expression as a function of the difference in enrichment of chromatin for three different chromatin-associated proteins.

FIGS. 7a-f show the results of comparative analysis of enhancer clustering near genes being differentially expressed and genes not being differentially expressed.

FIG. 8 provides a summary of the results of CUP-chip and expression experiments.

FIGS. 9a-g depict the results of verification studies of histone-modification-based prediction of enhancers.

FIG. 10 depicts the results of studies showing that predicted ES enhancers are enriched in known ES-specific transcription factors.

FIGS. 11a and b show the results of comparative analysis of promoter histone modifications in differentially expressed genes and repressed genes.

FIGS. 12a-f show plots of the relationship between differential enrichment of chromatin with various chromatin-associated proteins and differential gene expression.

FIGS. 13a and b graphically depict the results of a comparison of the observed distribution of adjacent TSS-TSS and CTCF-CTCF distances with what would be expected with random placement of sites.

FIG. 14a shows the results of comparative analysis of the distribution the closest enhancer-TSS distance in genes differentially expressed and genes not being differentially expressed; 14b shows the correlation between enhancer numbers and differential gene expression.

FIGS. 15a-f show the results of a parallel analysis to that shown in FIG. 7, this time using TSS-distal p300 sites rather than enhancers.

### DETAILED DESCRIPTION OF THE INVENTION

Abbreviations: ChIP, chromatin immunoprecipitation; ChM-chip, chromatin immunoprecipitation coupled with DNA microarrays; ChIP-Seq, chromatin immunoprecipitation coupled with high-throughput parallel sequencing; dES, BMP4 differentiated embryonic stem cells; ES, embryonic stem cells; GM, GM06990 lymphoblast cell line; H3, histone H3; H3K4Me1, histone H3 lysine 4 monomethylation; H3K4Me2, histone H3 lysine 4 dimethylation; H3K4Me3, histone H3 lysine 4 trimethylation; H3K9Ac, histone H3 lysine 9 acetylation; H3K18Ac, histone H3 lysine 18 acetylation; H3K27Ac, histone H3 lysine 27 acetylation; IMR90, fetal fibroblast cell line; K562, leukemia cell line K562; TSS(s), transcription start site(s).

### Methods

### Cell Culture

Passage 32 H1 cells were grown in mTeSR1 medium [45] on Matrigel (BD Biosciences, San Jose, Calif.), for 5 passages. 15×10 cm² dishes were grown using standard mTeSR1 culture conditions and 20×10 cm² dishes were cultured in mTeSR1 supplemented with 200 ng/ml BMP4 (RND systems, Minneapolis, Minn.). 5 days post passage, when cells were approximately 70% confluent, H1 p32 cells grown in unmodified mTeSR1 were cross-linked. To cross-link, 2.5 ml of cross-linking buffer (5M NaCl, 0.5M EDTA, 0.5M EGTA, 1M HEPES pH 8, 37% fresh formaldehyde) was added to 10 ml culture medium and incubated at 37° C. for 30 minutes, 1.25 ml of 2.5M glycine was added to stop the cross-linking reaction. Cells were removed from the culture dishes with a cell scraper, and collected by centrifugation for 10 minutes at 2500 rpm at 4° C. Cells were washed three times with cold PBS. After the final spin, cells were pelleted and flash frozen using liquid nitrogen. BMP4-treated cells were subjected to the same procedure after 6 days of exposure.

K562 (#CCL-243) cells were acquired from ATCC (www.atcc.org). K562 cells were grown to a density of 2.5×10⁵ cells/mL in Iscove's modified Dulbecco's medium with 4 mM L-glutamine containing 1.5 g/L sodium bicarbonate, and 10% fetal bovine serum at 37° C., 5% CO2. GM06990 (#GM06990) B-lymphocyte cells were acquired from Coriell (www.ccr.coriell.org). GM cells were grown to a density of 2.5×10⁵ cells/mL in RPMI 1640 medium with 2mM L-glutamine containing 15% fetal bovine serum at 37° C., 5% CO2. HeLa growth conditions were previously described [30].

### ChIP-chip Analysis

ChIP-chip procedure and antibodies against p300, TAF1, histone H3, H3K4Me1, H3K4Me2, H3K4Me3, and CTCF were previously described [30,39,46]. Additional antibodies are commercially available [α-H3K9Ac Abcam ab4441; α-H3K18Ac Abcam ab1191; and α-H3K27Ac Abcam ab4729]. All ChIP-chip experiments were completed in triplicate, except for those with normal and BMP4-treated ES cells. All ChIP-DNA samples were hybridized to NimbleGen ENCODE HG17 microarrays (NimbleGen Systems). DNA was labeled according to NimbleGen Systems' protocol. Samples were hybridized at 42° C. for 16 hours on a MAUI 12-bay hybridization station (BioMicro Systems). Microarrays were washed, scanned and stripped for re-use following protocols from NimbleGen Systems. Gene expression data for HeLa, K562, and GM cells were obtained using HU133 Plus 2.0 microarrays (Affymetrix).

Identification of CTCF and p300 Binding Sites

The Mpeak program can reliably detect binding sites of transcription factors, and has worked well in previous studies to identify TAF1, CTCF, and p300 binding sites [30,39,40,46]. We used the Mpeak program to determine binding sites of CTCF [39] and p300 [30] peaks. Specifically, we called a CTCF peak such if there was a stretch of 4 probes separated by at most 300 by that were at least 2.5 standard deviations above the mean. For p300, we used a simple FDR cutoff of 0.0001 to define peaks as in Heintzman et al. We used different parameters for consistency with previous publications, but swapping these parameters did not vary the results significantly.

### Enhancer Predictions

The procedure used to predict enhancers follows closely that in Heintzman et al. [30]. Specifically, we first binned the tiling ChIP-chip data into 100 by bins, averaging multiple probes that fell into the same bin. Empty bins were interpolated if the distance between flanking non-empty bins was less than 1 kb, and set to 0 otherwise. We scanned this binned data, keeping only those windows 1) in the top 10% of the intensity distribution and 2) having H3K4Me1 and H3K4Me3 profiles in the top 1% of all windows using the same training set of sites as in Heintzman et al (Figure la,b). We used a discriminative filter on H3K4Me1 and H3K4Me3 to keep only those sites that correlated with the averaged enhancer training set more than the promoter training set. Finally, we applied a descriptive filter on H3K4Me1 and H3K4Me3, keeping only those remaining predictions having a correlation of at least 0.5 with an averaged training set.

### Expression Array Analysis

We used the GCRMA package [47] to normalize Affymetrix mRNA expression arrays for HeLa, GM, and K562 cell types. For every pair of these cell types, we also used GCRMA to find differentially expressed and repressed genes using a p-value cutoff of 0.01 in conjunction with a fold change cutoff of 2.0. The expression data for ES and dES cell types were generated using the Nimblegen platform, and thus were not directly comparable to the Affymetrix expression data. As such, we could only use this expression data to compare ES and dES cell types. As a conservative measure of differential expression, we used a fold-change cutoff of 2.

### Gene Expression Analysis for ES and dES Cells

For gene expression analysis, we isolated the total RNA from H1 ES cells or BMP4-treated cells using Trizol (Invitrogen, Carlsbad, Calif.) according to the manufacturer's recommendations. PolyA RNA was then isolated using the Oligotex mRNA Mini Kit (Qiagen). The mRNA's were then reversed transcribed, labeled, mixed with differently labeled sonicated genomic DNA, and hybridized to a single array that tiled transcripts from approximately 36,000 human loci from the hg17 assembly (NimbleGen Systems). Detailed descriptions of array design, labeling, hybridization and data analysis are provided below. We set the expression level of genes in undifferentiated cells as 1 and calculated the relative fold change of individual genes in the dES cells.

Randomization and p-Values

To determine the expected distribution of adjacent element-to-element distances, we randomly placed the same number of elements into the ENCODE regions, with each base having an equal probability of being selected. To avoid complications such as repeat-masked regions, we restricted our sampling to only those regions covered by the NimbleGen tiling array.

The p-values for correlations were obtained by using the Matlab corr function. This p-value measures the probability that there is no correlation between the two variables, against the alternative that the correlation is non-zero. The p-values for Wilcoxon rank sum tests were obtained from the Matlab ranksum function.

### Gene Expression Data Analysis for ES and dES Cells

The Human Whole Genome Expression arrays containing ˜385,000 60-mer probes were manufactured by NimbleGen Systems (http://www.nimblegen.com). This array design tiles transcripts from approximately 36,000 human locus identifiers for the hg17 (UCSC) assembly with typically 10 or 11 probes per transcript.

Total RNA was enriched for the polyA fraction using Oligotex mRNA Mini Kit (Qiagen). Enriched mRNA (250 ng) was primed using random hexamers and reverse transcribed using Superscript III (Invitrogen) in the presence of 5-(3-aminoallyl)-dUTP (Ambion). The purified product was coupled to Cy5-NHS ester (Amersham). Similarly, sonicated genomic DNA (2 μg) was primed with random octamers and labeled using Klenow fragments in the presence of 5-(3-aminoallyl)-dUTP. The resulting product was coupled to Cy3-NHS ester (Amersham). Cy3-labeled genomic DNA (4.5 μg) was used as a reference and added along with the Cy5-labeled mRNA sample (2 μg) onto each array. Hybridizations were performed in 3.6×SSC buffer with 35% formamide and 0.07% SDS at 42° C. overnight. Arrays were then washed, dried, and scanned using a GenePix 4000B scanner.

Gene expression raw data were extracted using NimbleScan software v2.1. Considering that the signal distribution of the RNA sample is distinct from that of the gDNA sample, the signal intensities from RNA channels in all eight arrays were normalized with the Robust Multiple-chip Analysis (RMA) algorithm [47]. Separately, the same normalization procedure was performed on the signals from the gDNA samples. For a given gene, the median-adjusted ratio between its normalized intensity from the RNA channel and that from the gDNA channel was then calculated as follows:

Ratio=intensity from RNA channel/(intensity from gDNA channel+median intensity of all genes from the gDNA channel).

We found that this median-adjusted ratio gave the most consistent results when compared to other published human ES cell expression data, such as SAGE library information available from the Cancer Genome Anatomy Project (CGAP). Consequently, we used this median-adjusted ratio as the measurement for the gene expression level.

### Results

Mapping of Chromatin Modifications, TAF1, p300, and CTCF Binding in 1% of the Human Genome in Diverse Cell Types

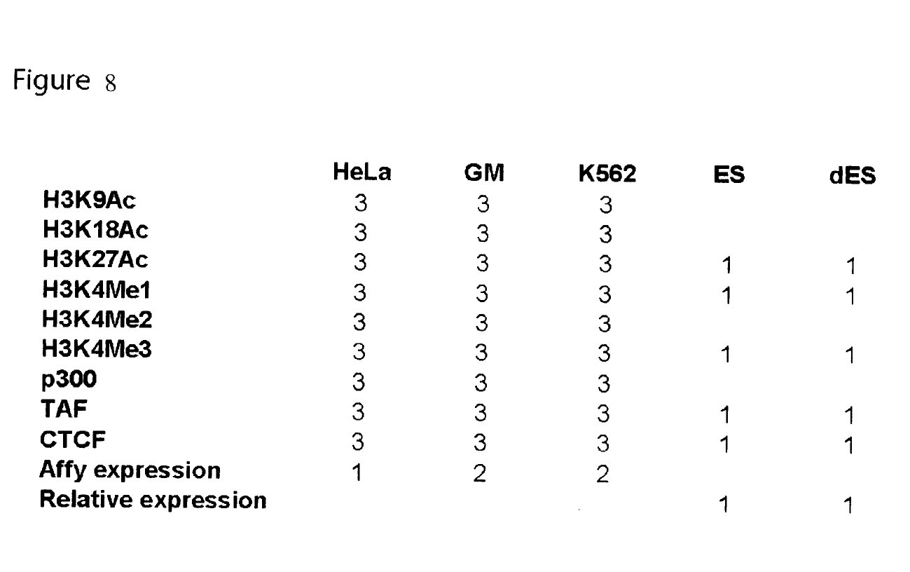

We performed ChIP-chip analysis [30] to determine the chromatin modification patterns along 44 human loci selected by the ENCODE consortium as common targets for genomic analysis [31], totaling 30 Mbp. We investigated the patterns of six specific histone modifications: acetylated histone H3 lysine 9, 18 and 27 (H3K9Ac, H3K18Ac and H3K27Ac), and mono-, di- and tri-methylated histone H3 lysine 4 (H3K4Me1, H3K4Me2, and H3K4Me3). We also examined binding of a component of the basal transcriptional machinery TAF1 in all five cell types to identify active promoters, along with the transcriptional coactivator p300 in HeLa, GM, and K562 cells to identify enhancers [32] (FIG. 8). ChIP samples were amplified, labeled, and hybridized to tiling oligonucleotide microarrays covering the nonrepetitive sequences of 30 Mbp at 38-bp resolution. Each array was loess normalized, and replicates were quantile normalized to determine average enrichments for each marker at every probe, generating highresolution maps of histone modifications and transcriptional regulator binding for 1% of the human genome.

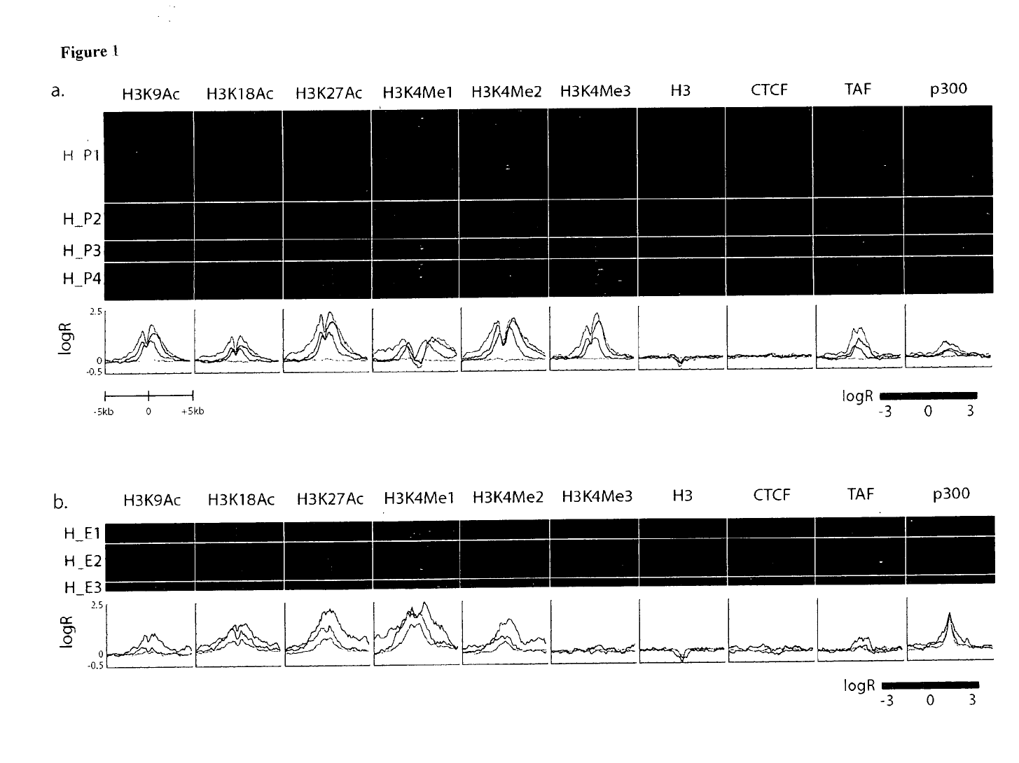

Previously, we demonstrated that active promoters and enhancers could be determined by distinct chromatin signatures of H3K4Me1 and H3K4Me3 at these functional elements [30]. Curiously, we had not observed any consistent enrichment of acetylated histones near enhancers, even those bound by the known histone acetyltransferase p300. One possible explanation for this is the specificity of the antigen recognition of the pan-H3 and H4 acetylation antibodies used in the previous study. We hypothesized that using antibodies specific for individual acetylated histones would improve recovery of consistently acetylated histones, especially at p300 binding sites. Focusing on HeLa cells, we indeed found that three additional histone modification marks, namely H3K9Ac, H3K18Ac and H3K27Ac are also part of the chromatin patterns at promoters and enhancers. All three acetylation marks localize to active transcription start sites (TSSs), and remain absent, as do other chromatin modifications, at inactive promoters (FIG. 1 A). These results agree with individual promoter studies observing acetylation or hyperacetylation at active promoters [17,32,33], as well as with large-scale histone modification studies in yeast [34,35]. HeLa enhancers marked by distal p300 binding sites show clear enrichment of H3K18Ac and H3K27Ac, while H3K9Ac is much reduced (FIG. 1B). These results indicate that H3K9Ac is preferentially associated with active promoters, while H3K18Ac and H3K27Ac are associated with both promoters and enhancers.

Most Human Promoters are Universally Associated With a Set of Active Chromatin Marks in Different Cell Types

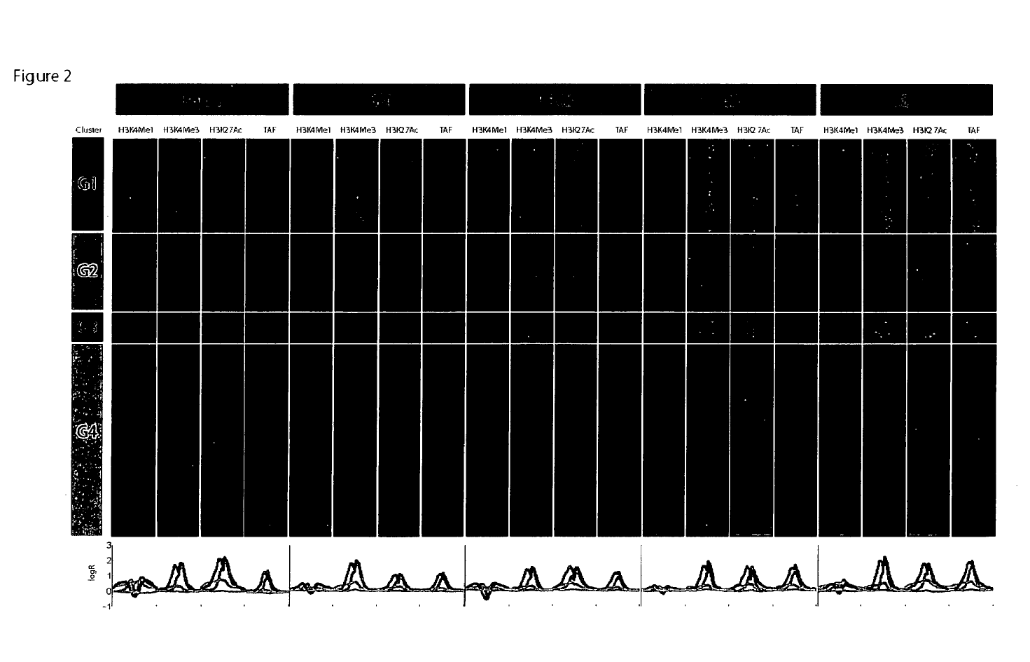

A cell's gene expression program uniquely defines its cell type, and modulation of the chromatin state of a cell is a key component of this program [34,36]. Given the diversity of the five cell types used in this study, we hypothesized that the chromatin modifications at promoters would uniquely define each cell type. To visualize the cell-type specificity of chromatin modification patterns at promoters, we simultaneously clustered the ChIP enrichment ratios for three histone modifications associated with active promoters (H3K4Me1, H3K4Me3 and H3K27Ac) and TAF1 within 10 kb windows centered at Gencode [37] TSSs for all cell types. We expected to recover large clusters of promoters specific to each cell type. Unexpectedly, however, we found that the chromatin signatures at virtually all TSSs were remarkably similar across cell types (FIG. 2).

Almost half (1296/2690=48.2%) of the promoters belonged to cluster G4, which generally lacks enrichment of chromatin marks typically found at active promoters. For the remaining clusters, the chromatin modification patterns appeared nearly identical across all five cell types. To quantify this, we defined a cell type's enrichment profile as the sum of the log ratio enrichment values of H3K4Me1, H3K4Me3, H3K27Ac, and TAF1 for each Gencode gene. We then calculated the Pearson correlation coefficient between enrichment profiles from different cell types (Table 1a). The enrichment profiles were highly correlated between all pairs of cell types, with an average correlation coefficient of 0.79, supporting the notion of the generally invariant nature of the chromatin marks at TSSs. Thus, this large-scale view indicated that roughly half of the promoters were consistently inactive across these five cell types, and that the remaining promoters were in general commonly marked by common histone modification patterns.

### CTCF Binding in the Genome is Generally Cell-Type Invariant

Since the cell-type specificity of epigenetic marks at promoters appears limited, we examined two other classes of cis-regulatory elements to determine if they were localized in a cell-type specific manner Insulator elements play key roles in restricting enhancers from activating inappropriate promoters, thereby defining the boundaries of gene regulatory domains [26].

Nearly all insulator elements that have been experimentally defined in the mammalian genome require the insulator binding protein CTCF to function [38]. Our previous genome-wide location analysis of the insulator binding protein CTCF in human fibroblasts indicated that CTCF binding is closely correlated with the distribution of genes, and is highly conserved throughout evolution, consistent with its key role in insulator function [39]. It is possible that CTCF localization could vary between cell types, contributing to cell-type specific gene expression. To test this hypothesis, we performed ChIP-chip to map CTCF binding sites in the ENCODE regions in all five cell types. After loess normalization, we used the Mpeak program [40] to identify CTCF binding sites (see Methods). We used a consistent set of parameters, calling a binding site such when at least 4 probes within a 300 by window were enriched at least 2.5 standard deviations above the mean. Using this method, there was an average of 517 CTCF binding sites identified for each cell type. On average, the overlap of CTCF binding sites from different cell types was a remarkable 82.8%, supporting the notion that CTCF binding sites are indeed cell-type independent, at a degree that is much higher than previously appreciated.

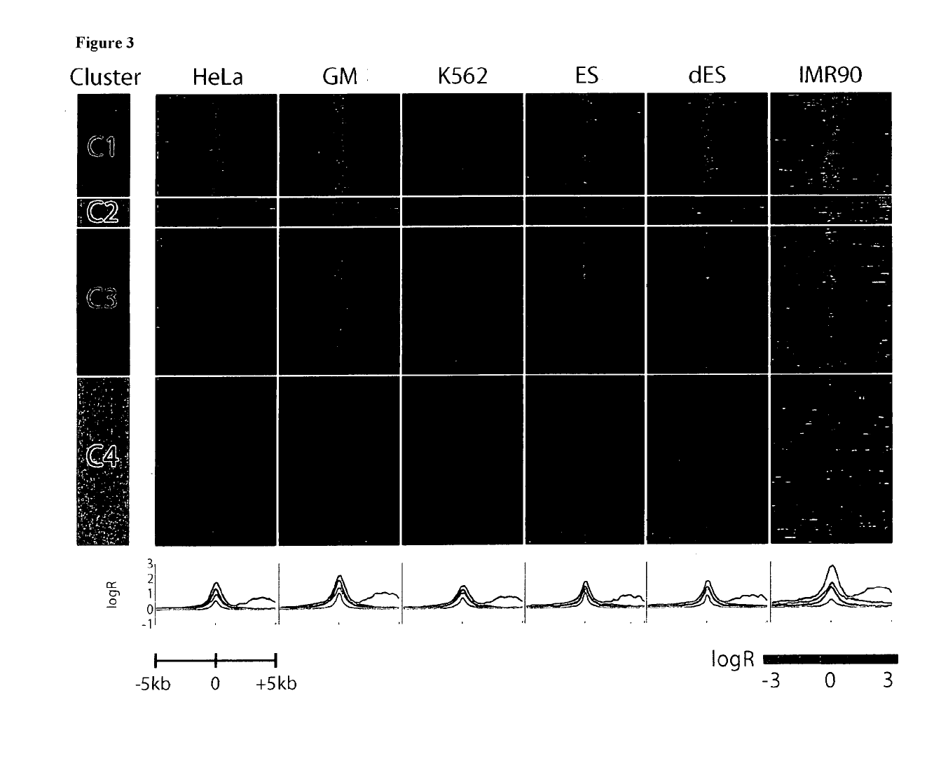

Peak finding is not perfect, so to further assess the cell-type specificity of CTCF binding, we merged CTCF binding sites found within 2.5 kb from sites in different cell types, giving a set of 729 non-redundant sites. To visualize the cell-type specificity of CTCF, we then created a heat-map of CTCF binding centered at these sites across all five cell types (FIG. 3). Strikingly, the correspondence between all cell types was nearly identical. Computing the enrichment profile of CTCF for each of the five cell types, we found that the average Pearson correlation coefficient between all pairs of profiles was remarkably high at 0.72 (Table 1b), comparable to the correlation coefficient of 0.79 observed at promoters. These results indicated that CTCF binding is largely cell-type invariant. We used this set of 729 CTCF binding sites for further analysis.

### Enhancers are Cell-Type Specific

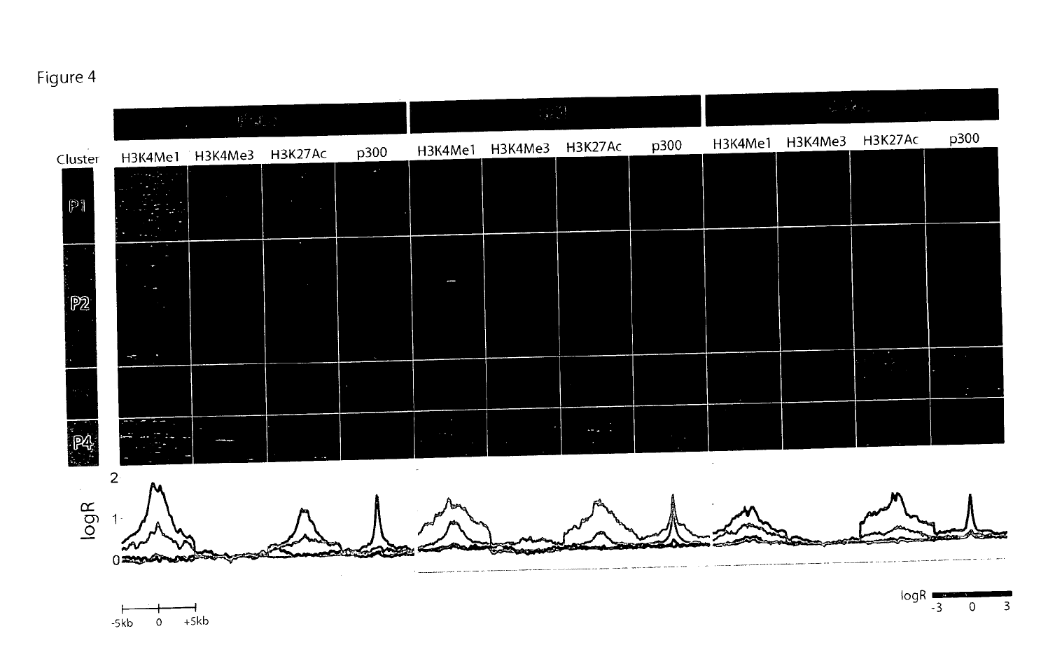

Not observing epigenetic cell-type specificity at promoters and insulators, we tested if nhancers were localized in a cell-type specific manner. First, using very stringent criteria, we defined active enhancers to be binding sites of p300, a histone acetyltransferase and coactivator protein. We identified a total of 411 TSS-distal p300 binding sites in HeLa, GM, and K562 cell lines. We observed that, unlike CTCF and chromatin modifications at promoters, the localization of p300 binding sites appears unique to each cell type in the three cell types where p300 ChIP-chip analysis was performed (FIG. 4). The notion of cell-type specificity of p300 binding sites was supported by the extremely low correlations observed: the average pair-wise Pearson correlation coefficient at p300 binding sites was -0.11 (Table 1c), compared to the much higher correlations 0.79 and 0.72 observed at promoters and insulators, respectively. More strikingly, p300 binding sites were largely cell-type specific: of the 411 distal peaks recovered from the three cell types, the vast majority (378, 92.9%) were unique to a single cell type, 29 (7.1%) were shared among exactly two cell types, and 4 (1.0%) were common among all three cell types.

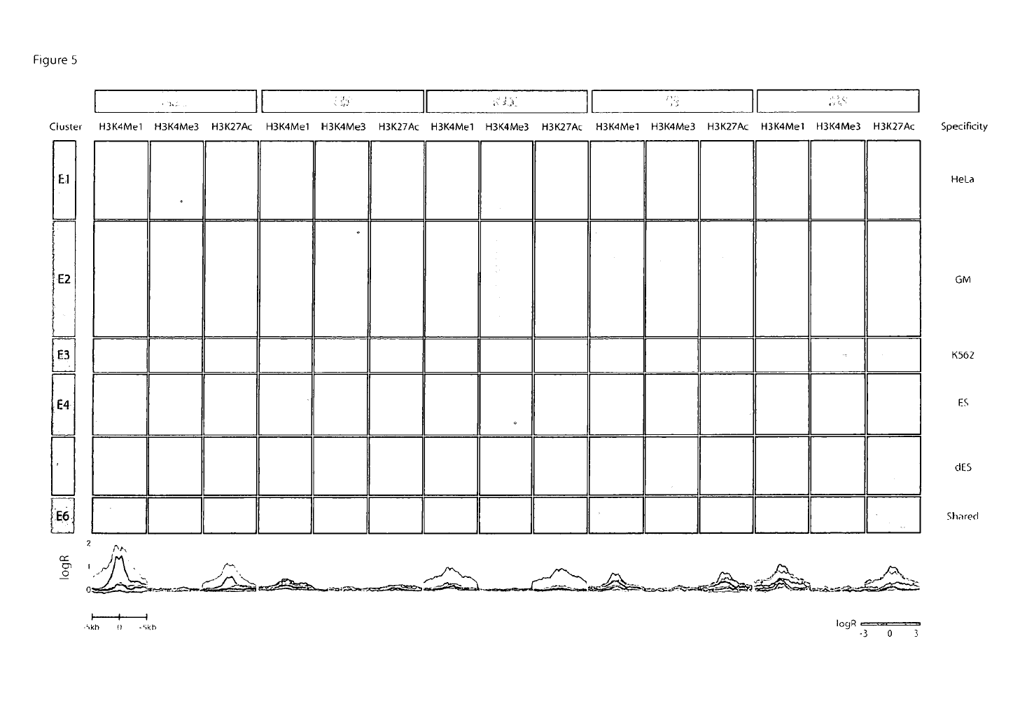

While the presence of p300 is sufficient to indicate an enhancer, p300 is not necessarily found at all enhancers. To obtain a more complete catalog of enhancers, we relied on the approach of Heintzman et al [30] (see Methods). Briefly, using a sliding window on H3K4Me1 and H3K4Me3, we scanned for chromatin modifications resembling a training set of enhancer patterns defined by the p300 binding sites in HeLa cells. We then kept only those predictions having a Pearson correlation of at least 0.5 with the training set and that had histone modification patterns correlating more with the enhancer training set than with promoter patterns (Tables 2-6). Consistent with the chromatin signatures of p300 binding sites, the putative enhancers were highly enriched in the chromatin modifications H3K4Me1 and H3K27Ac, but had no enrichment of H3K4Me3 (FIG. 5). This was in agreement with our previous findings, in which several predicted enhancers were functionally validated [30].

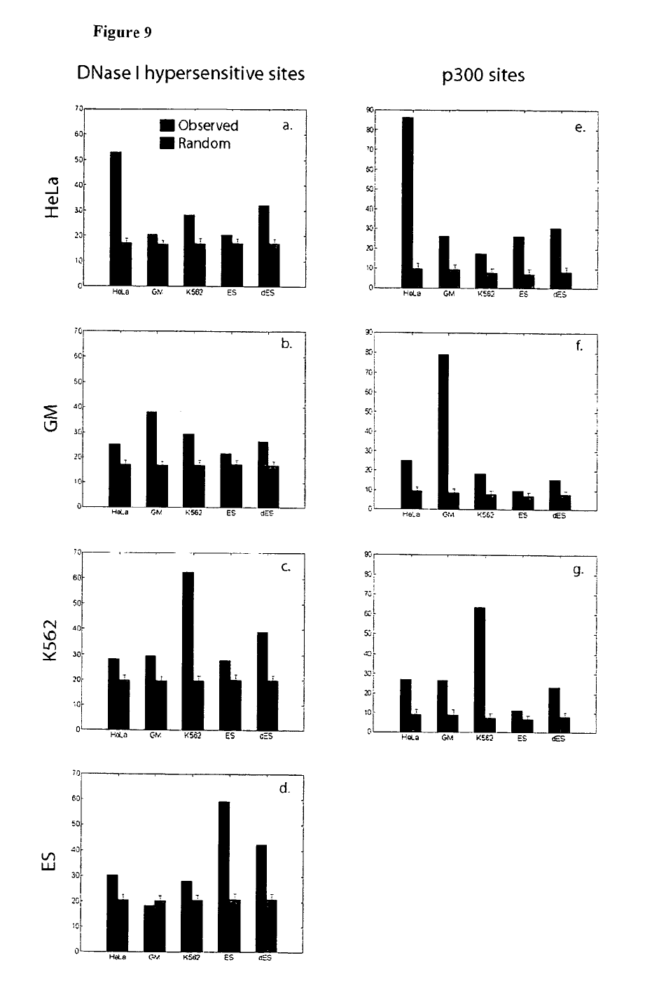

Several lines of evidence supported the idea that the histone-modification-based predictions of enhancers are truly enhancers. First, we compared the predicted enhancers to DNase I hypersensitive (HS) sites, as hypersensitivity is a hallmark of enhancers. Using a recently published set of HS sites [40] mapped in HeLa, GM, K562, and H9 ES cells, we computed the percentage of predicted enhancers within 2.5 kb of HS sites (FIG. 9a-d). For comparison, we also computed the overlap percentage of 100 sets of randomly placed enhancers restricted to regions on the ChIPchip microarray. We noticed that predicted enhancers in HeLa (53.0% overlap, Z-score=20.4, p=3.2E-93), GM (38.2% overlap, Z-score=14.4, p=5.1E-47), K562 (overlap=62.6%, Z-score =22.7, p=3.9E-114), and overlap, Z-score=18.0, p=1.0E-72) were enriched in HS sites in their respective cell types. Thus, the notion that the predicted enhancers actually are enhancers was supported by HS data. We also noticed that there were often cases where predicted enhancers from one cell type overlapped significantly with another cell type, suggesting that there is some sharing of enhancers between cell types. However, it was always the case that the overlap was highest for predicted enhancers and HS sites of the same cell type, indicating that many of the enhancers are cell-type specific.

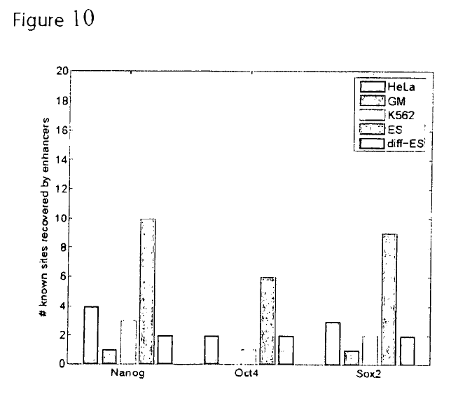

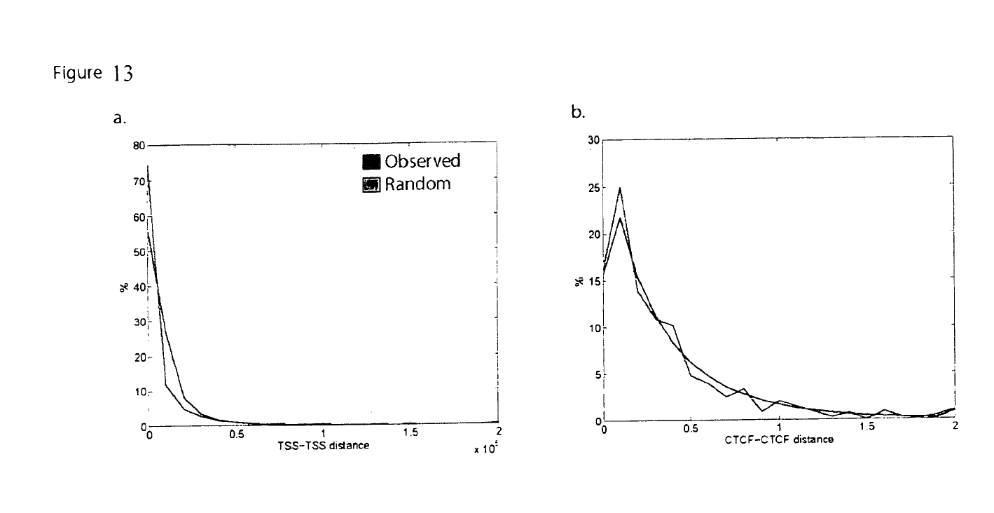

Second, enhancers were defined to be regions in the genome bound to transcription factors and co-activators. To verify the predicted enhancers, we compared their overlap with p300 binding sites. For every cell line where we mapped p300 binding, we observed significant enrichment of predicted enhancers at p300 binding sites (HeLa: 86.4% overlap, Z-score=27.7 , p=2.9E-169; GM: 79.2% overlap, Z-score=35.7, p=4.6E-279; K562: 63.6% overlap, Z-score=23.3, p=1.7E-120) (FIG. 13e-g), again supporting the notion that the predicted enhancers were real. To further validate the predicted enhancers in the ES cell line, we relied on the definition of enhancers as binding sites for transcription factors and compared the predicted enhancers with previously mapped binding sites for the ES-specific transcription factors Oct4, Sox2, and Nanog [42] (FIG. 10). Compared to predicted enhancers from other cell types, we noticed greater than 2-fold enrichment of the predicted ES enhancers with these ES-specific factors. Although we did not have the corresponding functional data for the dES cell type, several lines of evidence suggested that they were also real. First, like the other cell types, the histone modification patterns at predicted dES enhancers were enriched in H3K4Me1 and H3K27Ac, but lacked H3K4Me3. Second, there was a significant enrichment of dES enhancers at HS sites and p300 binding sites from the other cell types, indicating that at least some of these dES enhancers were real.

Next, we addressed the cell-type specificity of the predicted enhancers. As we expected the localization pattern of enhancers to resemble that of p300, we hypothesized that the predicted enhancers were also localized in a cell-type specific manner. To see if this was supported visually, we performed computational clustering on all predicted enhancers, encompassing chromatin modifications from all five cell types (FIG. 5). Like p300 binding sites, the predicted enhancers are often cell-type specific: of the 1423 non-redundant putative enhancers recovered from all cell types, 908 (63.8%) were unique to one cell type, 345 (24.2%) were shared between two cell types, 128 (9.0%) between three cell types, and 34 (2.4%) between four cell types. Only 8 enhancers (0.6%) were common among all five cell types. To quantify the cell-type specificity of enhancers further, we computed the enrichment profiles of histone modifications for each cell type, and found the average Pearson correlation coefficient between all pairs of cell types to be merely 0.14 (Table 1d). This low correlation was comparable to the average correlation observed at p300, but was strikingly different from those observed at promoters and CTCF binding sites. These results indicated that chromatin modifications at enhancers distinguish between cell types more so than chromatin modifications at promoters or CTCF binding at insulators.

### Explaining Cell-Type Specific Gene Expression

Since promoters, insulators, and enhancers are critical for regulating the expression of each gene, we expected that differences in chromatin modifications or transcription factor binding to these elements between different cell types might help explain cell-type specific gene expression program. To better define the roles of each class of element in differential gene expression, we focused on a subset of 54 genes that show at least 2-fold differential transcription between any pairs of two cell types from HeLa, K562 and GM.

Changes in Promoter Chromatin Sstructure at Differentially Expressed Genes Correlated With Transcriptional Changes

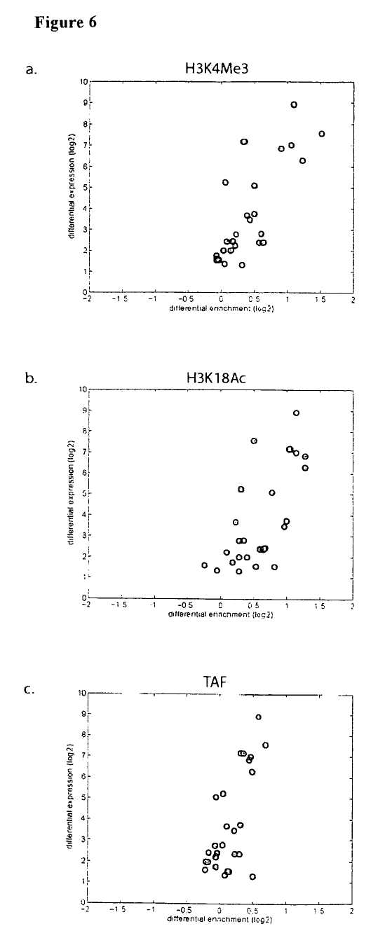

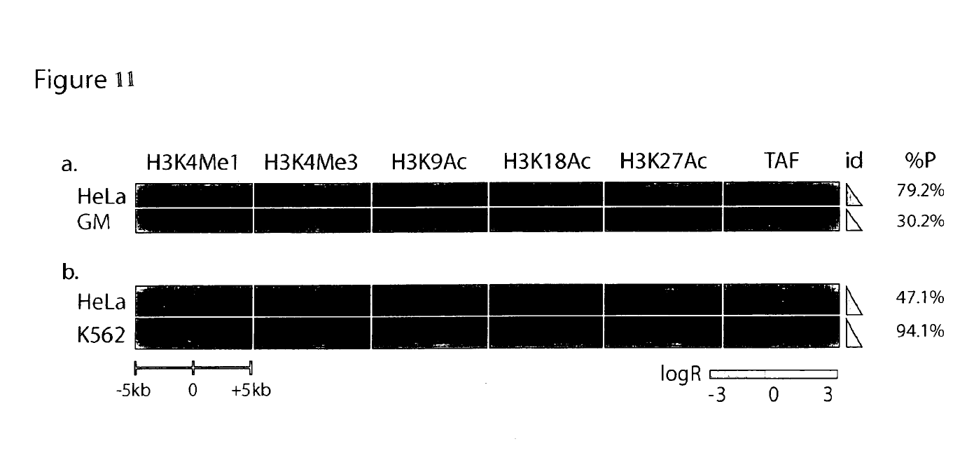

We have observed that the histone modification patterns at promoters across all five cell types are invariant at a global level (FIG. 1). But this is likely because the vast majority of genes are expressed at similar levels between the cell types. For this reason, we focused analysis on differentially expressed genes in HeLa, GM, and K562 cells, for which we had Affymetrix expression data. For each pair of cell types, we used the GCRMA package with a p-value cutoff of 0.01 and a fold-change cutoff of 2.0, to find differentially expressed genes. Of the 426 genes with expression data in the ENCODE regions, we observed 54 genes differentially expressed 99 times between the three cell types. Previous studies have indicated that absolute gene expression levels correlate with histone modification enrichment at promoters [34,36]. We noticed that some differentially expressed genes had noticeable differences in chromatin enrichment (FIG. 11a), while others did not (FIG. 11b). To quantify this, we computed the change in enrichment of histone modifications at each of the differentially expressed genes and compared this to gene induction (FIGS. 6a-c, 12a-f). Indeed, we found a positive correlation between differential chromatin enrichment and differential induction, especially for H3K4Me3 (Pearson correlation coefficient c=0.74), H3K18Ac (c=0.69), and TAF1 (c=0.68). This observation was consistent with previous findings [34,36].

### Enhancers are Clustered

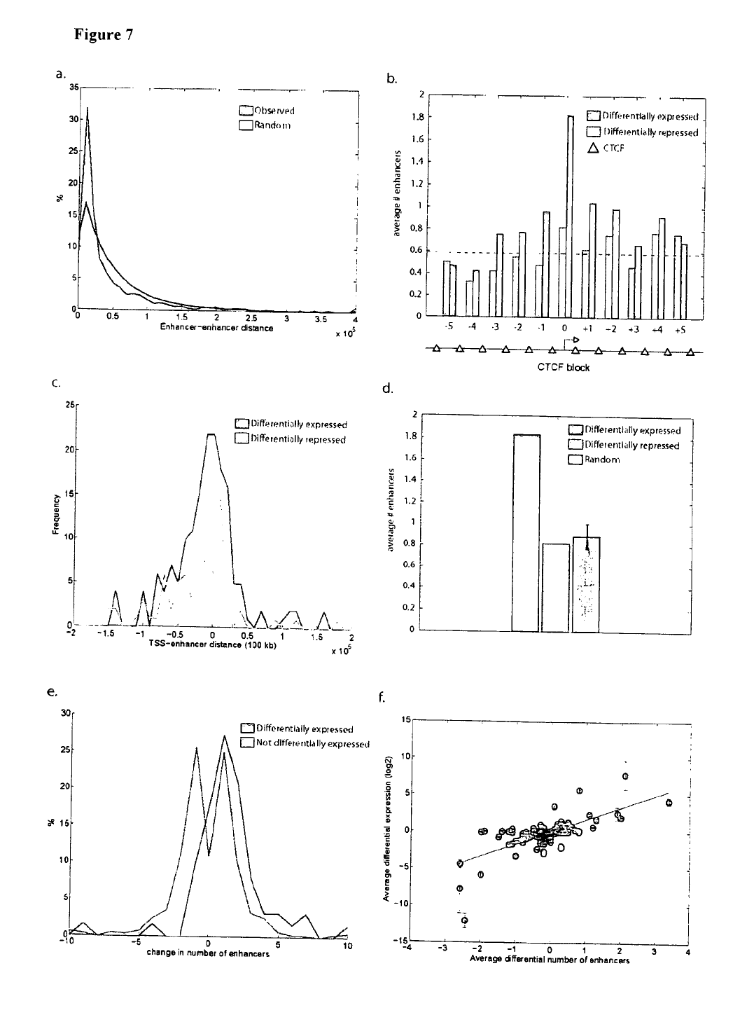

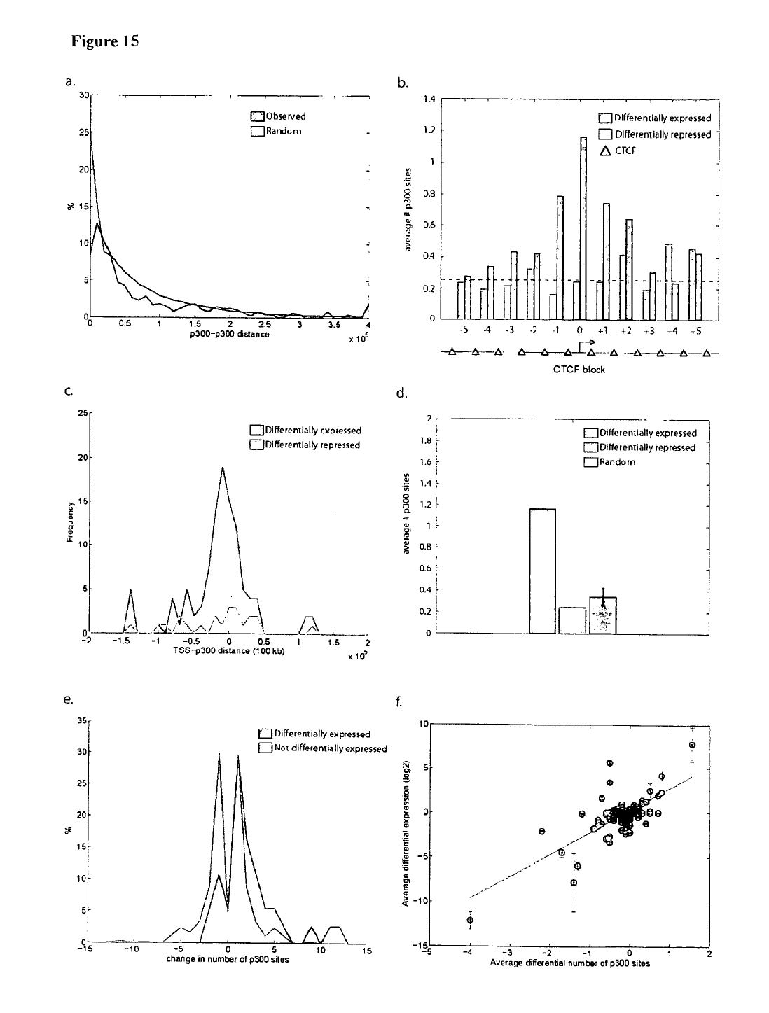

As described above, chromatin modifications and co-activator binding at enhancers are generally cell-type specific, supporting the notion of their role in mediating cell-type specific gene expression programs. To further understand the role of enhancers in cell-type specific gene expression, we examined the distribution of predicted enhancers in the human genome. To obtain a coarse view of the localization pattern of enhancers, we first examined the distribution of distances between adjacent enhancers. We observed that enhancers are more highly clustered than expected at random (Wilcoxon p=1.1E-27) (FIGS. 7a, 15a), a result which has also been observed in Drosophila [43]. In comparison, we observed an enrichment of small TSS-TSS distances, indicative of clustering of TSSs (Wilcoxon p=0, Matlab) (FIG. 13a), which is also consistent with previous studies [44]. However, the same cannot be said of CTCF-CTCF distances, which appear indistinguishable from what is expected from a random placement of sites (Wilcoxon p=0.1268) (FIG. 13b).

### Enhancers Were Enriched Near Cell-Type Specific Genes

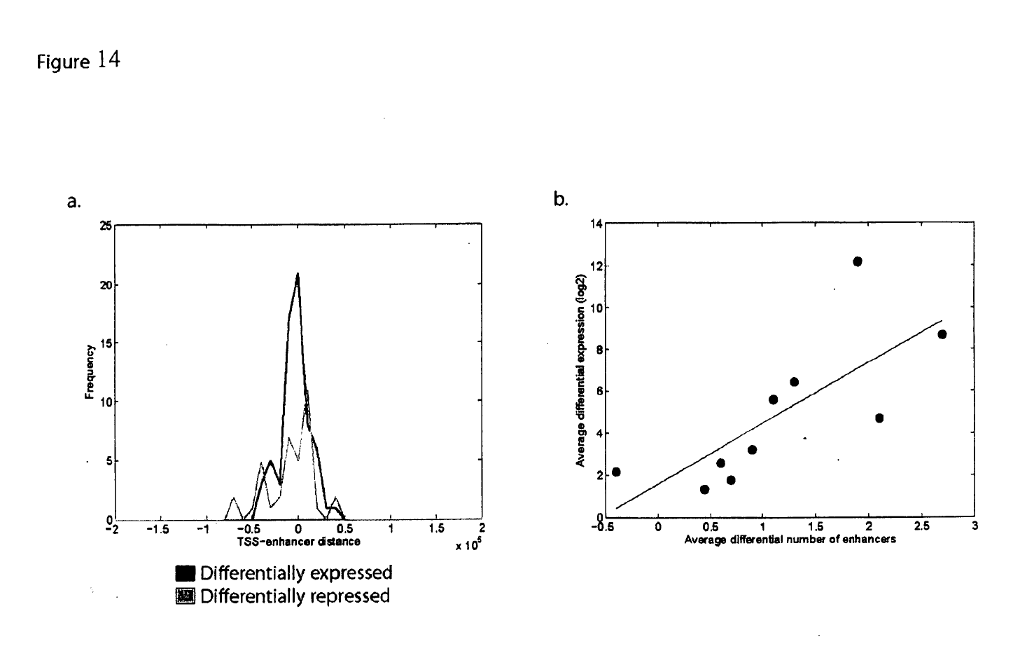

Having observed clustering of both enhancers and TSSs, we hypothesized that clustering of enhancers is associated with cell-type specific gene expression. To test this, we again focused on differentially expressed genes between pairs of cell types. We counted the number of enhancers near the differentially expressed genes in the neighboring domains defined by consensus CTCF sites. We found that enhancers were enriched near differentially expressed genes as compared to the same genes that are differentially repressed in another cell type, and this enrichment was largely confined within CTCF binding sites that directly flanked the gene's TSS (FIGS. 7b, 15b). On average within this block, there were 0.82 enhancers per differentially downregulated gene, while there were 1.83 enhancers per differentially upregulated gene (FIGS. 7c, 15c). This 2.2-fold difference indicated that the cell-type specific expression was influenced by enhancers and that the action of enhancers was distance-dependent and favoring proximal promoters. When we focused only on the enhancer closest to the differentially expressed gene rather than all enhancers within a CTCF block, we found smaller difference between the distributions of enhancers in up- and downregulated genes (FIG. 14a). The smaller 1.76-fold difference observed here further emphasizes that multiple enhancers, and not just the single closest enhancer, are likely required to regulate differential gene expression of a single promoter.

### Enhancers Acted Synergistically, and Effects of Individual Enhancers Were Generally Weak

There were 1355 enhancers identified in the HeLa, GM, and K562 cell lines (Tables 2-4), with nearly half (625 46.1%) in a CTCF block that also contained at least one of the 426 promoters for which we have expression data. Of these 426 promoters, 54 (12.7%) were differentially expressed in either HeLa, GM, or K562, and they were next to 158 (25.3%) of the 625 enhancers. While the enhancers were present in significantly enriched numbers near differentially expressed genes than would be expected for random placement (p=8.2E-17) (FIGS. 7d, 15d), the vast majority of enhancers were not near these cell-type specific genes, and likely contribute to expression of the other genes. This, together with the observation that enhancer localizations were vastly different between cell types, indicated that there is a massive rewiring of a cell's cis-regulatory network to give rise to changes in gene expression between cell types. Alternatively, given the recent findings that the human genome is pervasively expressed [8], it is possible that many enhancers are functioning to regulate the tissue-specific expression of many yet-uncharacterized genes.

The presence of multiple enhancers at differentially upregulated genes raises the possibility that enhancers may act cooperatively to regulate gene expression, and that the individual enhancer is weak. If enhancers generally modulate expression weakly, we would expect genes not differentially expressed to have minimal changes in enhancer numbers. To test this, we compared the distribution of changes in enhancer numbers for differentially expressed genes to those that were not. We found that the average change in enhancer counts was 1.47 for differentially expressed genes, whereas this figure was −0.05 for all other genes (t-test p=4.9E-6) (FIGS. 7e, 15e). This supports the notion that enhancers are generally weak, and that the cis-regulatory networks of different cells are vastly different while maintaining mostly similar expression profiles.

We noticed that while some active promoters are near a single enhancer, others are near multiple enhancers. This led us to ask if there is a relationship between a gene's induction level and the number of enhancers in the gene's CTCF block. Given that enhancers are positive-acting, there are several distinct possibilities: 1) the presence of multiple enhancers can have the same effect as the presence of a single enhancer, 2) enhancers have an additive effect on gene expression, or 3) enhancers synergistically upregulate gene expression such that the output is greater than the effect of adding individual enhancers. Indeed, we found that the latter is likely to be true: as the number of enhancers increased (FIGS. 7f, 15f, 14b), differential expression increased linearly on a log scale (Pearson correlation=0.69). Together, these results indicated that the effect of a single enhancer on gene expression is generally weak, and that gene activation by enhancers is highly cooperative and offers multiple points of control to fine-tune transcriptional output.

While these properties of enhancers were shared by predicted enhancers in each cell type, all of the above results also held when considering enhancers stringently defined as TSS-distal p300 binding sites (FIG. 15).

The identity of a mammalian cell is largely defined by its unique gene-expression profile. To understand the mechanisms that determine cell-type specific transcription, we have localized the binding sites of general transcription factors, the insulator protein CTCF and a number of histone modifications in 1% of the human genome in five diverse cell types. Using a previously defined chromatin signature for enhancers, we predicted a total of 1,423 non-redundant enhancers in these genome regions (Tables 2-6). The systematic, unbiased map of transcriptional regulatory elements in five different cell types allowed us to assess the differential roles of promoters, enhancers and insulators in cell-type specific gene expression. Contrary to expectations, we found that, from a global perspective, the chromatin modifications at promoters were remarkably invariant across cell types. But differences in enrichment of chromatin modifications did occur at a small set of promoters, and these differences correlated with differential gene expression. The binding of insulator protein CTCF to the genome was also nearly identical between different cells. In contrast, the majority of enhancers appeared to be epigenetically marked in a cell-type specific manner, and were enriched near genes with cell-type specific expression. Taken together, these observations strongly indicated that enhancers play important roles in driving cell-type specific gene-expression programs.

The observation that most promoters are commonly associated with active histone modifications in diverse cell types is surprising, and implies that most human promoters adopt a similar chromatin architecture in diverse cell types and lineages. Only a small fraction of the promoters take on different chromatin modifications that correlate with transcriptional changes of these genes. If the majority of the promoters exist in a similar chromatin configuration in different cell types, then what causes each cell to express its unique set of transcriptome? These results can be explained by a model in which the majority of promoters remain open and competent for transcriptional initiation in diverse cell types, but the actual level of transcription is modulated by the enhancers, whose activities are usually restricted to specific cell lineages and developmental stages. Consistent with this model, the enhancers that we identified in the ENCODE regions share several general properties: First, the enhancers are highly enriched near differentially expressed genes; Second, they are often located at considerable distances from active promoters and clustered together; Third, there is a remarkable synergistic relationship between enhancer numbers and differential expression of a gene, implying that single enhancers are often weak and have a small influence on gene expression. This model suggests that activation of cell-type specific gene expression will likely require the action of multiple enhancers.

The complex interaction of transcriptional regulators bound to cis-regulatory elements provides the basis for regulation of gene transcription. However, determining the role of each cis-regulatory element in gene expression has been limited to individual gene studies. Our results provide a large-scale, multiple cell-type view of promoters, enhancers and insulators, revealing important aspects of regulatory mechanisms, such as invariable insulator binding and highly specific enhancers that modulate the level of expression from promoters within CTCF blocks. The highly invariant nature of CTCF binding across this diverse assortment of cell types suggests that insulator binding is likely a stable feature of all human cells. This degree of consistency is higher than expected from our previous genome-wide study [37]. The results are indicative of genome-wide trends, and will provide the basis for the expansion of studies to include additional cell types, tissues, and organisms to define their regulatory networks.

The results and observations with respect to enhancers described herein lend themselves to application to various novel methods of monitoring and analysis in connection with the genome.

One aspect of the present invention is a method for identifying enhancer elements by analyzing portions of the genome for chromatin signatures found to be particularly associated with enhancers. Particular characteristics of the signatures associated with enhancers have been found to be enrichment in histone H3 lysine 4 monomethylation (H3K4Me1) and histone H3 lysine 27 acetylation (H3K27Ac). Other characteristics are enrichment in HS sites and overlap with transcription-factor binding sites, most particularly p300 binding sites. The analysis methods for enhancer-element identification employ, inter alia, ChIP-chip and ChIP-Seq analyses; antibodies against the desired transcription factors and modified histones; and digestion with DNase I.

In a further embodiment of the invention, the identification of enhancer elements provides for the analysis of the distribution of enhancers using computational clustering analysis. This enables the identification of differentially expressed and differentially unexpressed genes. This is a particularly powerful tool given our discovery that the effect of multiple enhancers is synergistic.

Not only have we discovered that enhancer signatures have features in common that enable the distinguishing of enhancers from promoters and other regulatory elements, but we have also discovered, as described above, that the enhancer signatures differ from each other on a cell-type specific basis within a given organism. Furthermore, again, we have demonstrated a correlation between differential gene expression and changes in enhancer numbers.

Accordingly, another aspect of the invention is the use of these tools in the diagnosis, prognosis and monitoring of disease, particularly cancer. However, the invention is by no means confined to methods useful in connection with cancer. Using techniques described herein, the characteristic enhancer signatures for both cancer cells and cells associated with other disease states can be identified. The diagnostic, prognostic and monitoring methods enabled by the disclosure herein involve analyzing chromatin samples from subjects for their signatures. This analysis is performed using the ChIP-chip analysis procedure described previously herein. Alternatively, the analysis can be performed using a ChIP-Seq procedure, whereby chromatin immunoprecipitation is combined with ultra high-throughput massive parallel sequencing. This procedure can be carried out as described by Jothi et al. [48] and Barski et al. [49]. Enhancer signatures are identified and further characterized by comparison with previously observed signatures known to be associated with particular cell types associated with disease states and the levels of gene expression in those cell types. The consequent identification of cell types and expression affords a basis for predicting disease states, diagnosing disease states and, in the latter case, monitoring the progress of the diseases and determining the appropriate parameters for treatment.

More particularly, one aspect of the invention is a diagnostic method for cancer and other diseases in a patient, comprising the steps of:
a) obtaining chromatin from a tissue, blood or plasma sample, or from a cell line, from the patient;
b) determining the signatures present in the chromatin; and
c) in the case wherein the quantity of chromatin signatures at a subset of enhancers associated with cancerous cells or with cells that are known to be present in association with other another disease state is above a set threshold, identifying the patient as likely having the cancer or other disease state.

This diagnostic method may well also lend itself to further diagnostic/predictive studies. The methodology described can be employed to determine if there is a significant correlation between a quantity of cancer- or other-disease-associated enhancers below a set threshold and absence of the cancer or other disease in a patient and/or a correlation between such a threshold quantity and the diminished likelihood that the patient will get the cancer or other disease.

Another aspect of the invention is a prognostic method for cancer or another disease state in a patient known already to have such a condition, comprising the steps of:
a) obtaining chromatin from a tissue, blood or plasma sample, or from a cell line, from the patient;
b) determining the quantity and distribution of enhancers in the chromatin that are associated with the cancer or other condition; and
c) using the results of the determination in step b) as a basis for assessing the optimal treatment regimen for the patient, for predicting the patient's response to the treatment and for predicting the likelihood or duration of survival of the patient.

Another aspect of the invention following from the prognostic method described immediately above is a method for monitoring the progress of treatment of a patient having cancer or another disease state, comprising the steps of:
a) obtaining, both before and after treatment, chromatin from a tissue, blood or plasma sample, or from a cell line, from the patient;
b) determining the change from before the treatment in quantity and distribution of enhancers in the chromatin that are associated with the cancer or other condition; and
c) using the results of the determination in step b) to 1) assess the effectiveness of the treatment regimen; 2) assess the need for any adjustments in said regimen; and 3) identify the specifics of any such adjustments.

Yet another aspect of the invention is a method for the identification of differentially expressed and differentially repressed genes in a genome segment from a particular cell type of a host, which comprises employing the techniques described herein previously for finding enhancer elements in a genome segment, followed by the further steps of:
d) analyzing the distribution of the enhancers using computational clustering analysis;
e) identifying those regions of the analyzed genome segment having enrichment and clustering of enhancers as containing a differentially expressed gene or genes; and
f) identifying those regions of the analyzed genome segment not having such enrichment and clustering as containing a differentially repressed gene or genes.
g)

TABLE 1
a. Gencode TSSs

| | HeLa | GM | K562 | ES | dES |
|---|---|---|---|---|---|
| HeLa | 1.00 | 0.84 | 0.80 | 0.80 | 0.82 |
| GM | | 1.00 | 0.79 | 0.79 | 0.76 |
| K562 | | | 1.00 | 0.76 | 0.78 |
| ES | | | | 1.00 | 0.82 |
| dES | | | | | 1.00 |

b. CTCF binding sites

| | HeLa | GM | K562 | ES | dES | IMR90 |
|---|---|---|---|---|---|---|
| HeLa | 1.00 | 0.87 | 0.79 | 0.65 | 0.76 | 0.61 |
| GM | | 1.00 | 0.84 | 0.68 | 0.78 | 0.59 |
| K562 | | | 1.00 | 0.65 | 0.76 | 0.60 |
| ES | | | | 1.00 | 0.83 | 0.64 |
| dES | | | | | 1.00 | 0.72 |
| IMR90 | | | | | | 1.00 |

c. p300 binding sites

| | HeLa | GM | K562 |
|---|---|---|---|
| HeLa | 1.00 | −0.13 | −0.12 |
| GM | | 1.00 | −0.08 |
| K562 | | | 1.00 |

d. Enhancers

| | HeLa | GM | K562 | ES | dES |
|---|---|---|---|---|---|
| HeLa | 1.00 | 0.10 | 0.07 | 0.14 | 0.26 |
| GM | | 1.00 | 0.16 | 0.04 | 0.07 |
| K562 | | | 1.00 | 0.04 | 0.19 |
| ES | | | | 1.00 | 0.36 |
| dES | | | | | 1.00 |

TABLE 2

| | | |
|---|---|---|
| ENm001 | 115454022 | chr7 |
| ENm001 | 115465922 | chr7 |
| ENm001 | 115493622 | chr7 |
| ENm001 | 115505722 | chr7 |
| ENm001 | 115551122 | chr7 |
| ENm001 | 115564522 | chr7 |
| ENm001 | 115574822 | chr7 |
| ENm001 | 115589122 | chr7 |
| ENm001 | 115598122 | chr7 |
| ENm001 | 115629122 | chr7 |
| ENm001 | 115637722 | chr7 |
| ENm001 | 115658622 | chr7 |
| ENm001 | 115667722 | chr7 |
| ENm001 | 115675322 | chr7 |
| ENm001 | 115677122 | chr7 |
| ENm001 | 115689522 | chr7 |
| ENm001 | 115699722 | chr7 |
| ENm001 | 115711122 | chr7 |
| ENm001 | 115717522 | chr7 |
| ENm001 | 115724522 | chr7 |
| ENm001 | 115726122 | chr7 |
| ENm001 | 115746222 | chr7 |
| ENm001 | 115805022 | chr7 |
| ENm001 | 115811022 | chr7 |
| ENm001 | 115817022 | chr7 |
| ENm001 | 115849422 | chr7 |
| ENm001 | 115866022 | chr7 |
| ENm001 | 115887622 | chr7 |
| ENm001 | 115915022 | chr7 |
| ENm001 | 115922922 | chr7 |
| ENm001 | 115924822 | chr7 |
| ENm001 | 115935822 | chr7 |
| ENm001 | 115941222 | chr7 |
| ENm001 | 115950322 | chr7 |
| ENm001 | 116012922 | chr7 |
| ENm001 | 116032022 | chr7 |
| ENm001 | 116037822 | chr7 |
| ENm001 | 116044622 | chr7 |
| ENm001 | 116070422 | chr7 |
| ENm001 | 116106322 | chr7 |
| ENm001 | 116358022 | chr7 |
| ENm001 | 116359922 | chr7 |
| ENm001 | 116366122 | chr7 |
| ENm001 | 116392522 | chr7 |
| ENm001 | 116493822 | chr7 |
| ENm001 | 116503922 | chr7 |
| ENm001 | 116814822 | chr7 |
| ENm001 | 116822122 | chr7 |
| ENm001 | 116840822 | chr7 |
| ENm001 | 116854022 | chr7 |
| ENm001 | 116879722 | chr7 |
| ENm001 | 116900122 | chr7 |
| ENm001 | 116917522 | chr7 |
| ENm001 | 116938022 | chr7 |
| ENm001 | 117010122 | chr7 |
| ENm001 | 117232322 | chr7 |
| ENm002 | 131437364 | chr5 |
| ENm002 | 131450064 | chr5 |
| ENm002 | 131458364 | chr5 |
| ENm002 | 131467364 | chr5 |
| ENm002 | 131578864 | chr5 |
| ENm002 | 131589264 | chr5 |
| ENm002 | 131618364 | chr5 |
| ENm002 | 131624764 | chr5 |
| ENm002 | 131629264 | chr5 |
| ENm002 | 131637064 | chr5 |
| ENm002 | 131728564 | chr5 |
| ENm002 | 131751464 | chr5 |
| ENm002 | 131774264 | chr5 |
| ENm002 | 131776564 | chr5 |
| ENm002 | 131786464 | chr5 |
| ENm002 | 131809664 | chr5 |
| ENm002 | 131822964 | chr5 |
| ENm002 | 132040864 | chr5 |
| ENm003 | 115978066 | chr11 |
| ENm003 | 116333866 | chr11 |
| ENm003 | 116335766 | chr11 |
| ENm003 | 116360666 | chr11 |
| ENm003 | 116386866 | chr11 |
| ENm003 | 116402766 | chr11 |
| ENm003 | 116413966 | chr11 |
| ENm003 | 116421266 | chr11 |
| ENm003 | 116439966 | chr11 |
| ENm003 | 116447866 | chr11 |
| ENm004 | 30349858 | chr22 |
| ENm004 | 30367558 | chr22 |
| ENm004 | 30550558 | chr22 |
| ENm004 | 30671758 | chr22 |
| ENm004 | 30673558 | chr22 |
| ENm004 | 31253158 | chr22 |
| ENm004 | 31260158 | chr22 |
| ENm004 | 31277358 | chr22 |
| ENm004 | 31290958 | chr22 |
| ENm004 | 31304958 | chr22 |
| ENm004 | 31312458 | chr22 |
| ENm004 | 31337458 | chr22 |
| ENm004 | 31343758 | chr22 |
| ENm004 | 31370458 | chr22 |
| ENm004 | 31396758 | chr22 |
| ENm004 | 31404558 | chr22 |
| ENm004 | 31416858 | chr22 |
| ENm004 | 31481958 | chr22 |
| ENm004 | 31524658 | chr22 |
| ENm004 | 31531258 | chr22 |
| ENm004 | 31716658 | chr22 |
| ENm005 | 32675687 | chr21 |
| ENm005 | 32681087 | chr21 |
| ENm005 | 32736887 | chr21 |
| ENm005 | 32744887 | chr21 |
| ENm005 | 32751387 | chr21 |
| ENm005 | 32758387 | chr21 |
| ENm005 | 32769487 | chr21 |
| ENm005 | 32789487 | chr21 |
| ENm005 | 32810387 | chr21 |
| ENm005 | 32817387 | chr21 |
| ENm005 | 32918887 | chr21 |
| ENm005 | 33102987 | chr21 |
| ENm005 | 33138487 | chr21 |
| ENm005 | 33497487 | chr21 |
| ENm005 | 33581387 | chr21 |
| ENm005 | 33676387 | chr21 |
| ENm005 | 33690187 | chr21 |
| ENm005 | 33699487 | chr21 |
| ENm005 | 33713487 | chr21 |
| ENm005 | 33848087 | chr21 |
| ENm005 | 33952087 | chr21 |
| ENm005 | 33979387 | chr21 |
| ENm005 | 34055187 | chr21 |
| ENm005 | 34094387 | chr21 |
| ENm005 | 34219187 | chr21 |
| ENm005 | 34230787 | chr21 |
| ENm005 | 34242187 | chr21 |
| ENm005 | 34264087 | chr21 |
| ENm005 | 34270287 | chr21 |
| ENm006 | 152669595 | chrX |
| ENm006 | 152679995 | chrX |
| ENm006 | 152688795 | chrX |
| ENm006 | 152828995 | chrX |
| ENm006 | 152861795 | chrX |
| ENm006 | 152868795 | chrX |
| ENm006 | 152881795 | chrX |
| ENm006 | 153074095 | chrX |
| ENm006 | 153179095 | chrX |
| ENm006 | 153237795 | chrX |
| ENm006 | 153332495 | chrX |
| ENm006 | 153388495 | chrX |
| ENm006 | 153390395 | chrX |
| ENm006 | 153392895 | chrX |
| ENm006 | 153395995 | chrX |
| ENm006 | 153522195 | chrX |
| ENm006 | 153591495 | chrX |
| ENm006 | 153597595 | chrX |
| ENm006 | 153680095 | chrX |
| ENm007 | 59037735 | chr19 |
| ENm007 | 59054035 | chr19 |
| ENm007 | 59175035 | chr19 |
| ENm007 | 59185135 | chr19 |
| ENm007 | 59197535 | chr19 |
| ENm007 | 59214435 | chr19 |
| ENm007 | 59404135 | chr19 |
| ENm007 | 59634435 | chr19 |
| ENm008 | 66451 | chr16 |
| ENm008 | 103851 | chr16 |
| ENm008 | 258151 | chr16 |
| ENm008 | 317551 | chr16 |
| ENm008 | 340651 | chr16 |
| ENm009 | 5258246 | chr11 |
| ENm009 | 5321746 | chr11 |
| ENm009 | 5345246 | chr11 |
| ENm009 | 5583846 | chr11 |
| ENm009 | 5715146 | chr11 |
| ENm010 | 26878511 | chr7 |
| ENm010 | 26885311 | chr7 |
| ENm010 | 26894111 | chr7 |
| ENm010 | 26911111 | chr7 |
| ENm010 | 26948511 | chr7 |
| ENm010 | 26990311 | chr7 |
| ENm010 | 27007011 | chr7 |
| ENm010 | 27159511 | chr7 |
| ENm011 | 1728342 | chr11 |
| ENm011 | 1739342 | chr11 |
| ENm011 | 1751042 | chr11 |
| ENm011 | 1760642 | chr11 |
| ENm011 | 1806242 | chr11 |
| ENm011 | 1812142 | chr11 |
| ENm011 | 1822842 | chr11 |
| ENm011 | 1841242 | chr11 |
| ENm011 | 2156942 | chr11 |
| ENm012 | 113701534 | chr7 |
| ENm012 | 113716534 | chr7 |
| ENm012 | 113737434 | chr7 |
| ENm012 | 113739234 | chr7 |
| ENm012 | 113762734 | chr7 |
| ENm012 | 113766234 | chr7 |
| ENm012 | 113769134 | chr7 |
| ENm012 | 113789534 | chr7 |
| ENm012 | 113808734 | chr7 |
| ENm012 | 113818034 | chr7 |
| ENm012 | 113894534 | chr7 |
| ENm012 | 113994134 | chr7 |
| ENm012 | 114024234 | chr7 |
| ENm012 | 114054734 | chr7 |
| ENm012 | 114086434 | chr7 |
| ENm012 | 114098734 | chr7 |
| ENm012 | 114164934 | chr7 |
| ENm012 | 114178734 | chr7 |
| ENm012 | 114213834 | chr7 |
| ENm012 | 114222034 | chr7 |
| ENm012 | 114243734 | chr7 |
| ENm012 | 114321934 | chr7 |
| ENm012 | 114331534 | chr7 |
| ENm012 | 114370334 | chr7 |
| ENm012 | 114465034 | chr7 |
| ENm013 | 89453190 | chr7 |
| ENm013 | 89485890 | chr7 |
| ENm013 | 89748290 | chr7 |
| ENm013 | 89804390 | chr7 |
| ENm013 | 89853390 | chr7 |
| ENm013 | 89881290 | chr7 |
| ENm013 | 89899090 | chr7 |
| ENm013 | 90090790 | chr7 |
| ENm013 | 90098890 | chr7 |
| ENm013 | 90439190 | chr7 |
| ENm013 | 90457190 | chr7 |
| ENm013 | 90515690 | chr7 |
| ENm013 | 90523790 | chr7 |
| ENm014 | 125729357 | chr7 |
| ENm014 | 125808657 | chr7 |
| ENm014 | 125922957 | chr7 |
| ENm014 | 125934757 | chr7 |
| ENm014 | 126051957 | chr7 |
| ENm014 | 126058457 | chr7 |
| ENm014 | 126116357 | chr7 |
| ENm014 | 126121857 | chr7 |
| ENm014 | 126171357 | chr7 |
| ENm014 | 126222257 | chr7 |
| ENm014 | 126671857 | chr7 |
| ENr111 | 29585766 | chr13 |
| ENr111 | 29598066 | chr13 |
| ENr111 | 29615266 | chr13 |
| ENr111 | 29773466 | chr13 |
| ENr111 | 29785366 | chr13 |
| ENr111 | 29803766 | chr13 |
| ENr111 | 29810566 | chr13 |
| ENr111 | 29812666 | chr13 |
| ENr111 | 29844166 | chr13 |
| ENr111 | 29881266 | chr13 |
| ENr111 | 29902866 | chr13 |
| ENr112 | 51897506 | chr2 |
| ENr112 | 51922206 | chr2 |
| ENr112 | 51951606 | chr2 |
| ENr112 | 52057306 | chr2 |
| ENr113 | 118678709 | chr4 |
| ENr113 | 118734009 | chr4 |
| ENr113 | 119004609 | chr4 |
| ENr113 | 119056809 | chr4 |
| ENr121 | 118454354 | chr2 |
| ENr122 | 59459451 | chr18 |
| ENr122 | 59477151 | chr18 |
| ENr122 | 59501151 | chr18 |
| ENr122 | 59544751 | chr18 |
| ENr122 | 59556151 | chr18 |
| ENr122 | 59593551 | chr18 |
| ENr122 | 59637351 | chr18 |
| ENr122 | 59685951 | chr18 |
| ENr122 | 59700751 | chr18 |
| ENr123 | 38655227 | chr12 |
| ENr123 | 38666827 | chr12 |
| ENr123 | 38691327 | chr12 |
| ENr123 | 38734027 | chr12 |
| ENr123 | 38736327 | chr12 |
| ENr123 | 38783727 | chr12 |
| ENr123 | 38828527 | chr12 |
| ENr123 | 38889327 | chr12 |
| ENr123 | 38906127 | chr12 |
| ENr123 | 38975027 | chr12 |
| ENr123 | 39006027 | chr12 |
| ENr131 | 234372075 | chr2 |
| ENr131 | 234381275 | chr2 |
| ENr131 | 234390375 | chr2 |
| ENr131 | 234398375 | chr2 |
| ENr131 | 234436775 | chr2 |
| ENr131 | 234448075 | chr2 |
| ENr131 | 234454875 | chr2 |
| ENr131 | 234507975 | chr2 |
| ENr131 | 234523475 | chr2 |
| ENr131 | 234530675 | chr2 |
| ENr131 | 234665375 | chr2 |
| ENr131 | 234672475 | chr2 |
| ENr131 | 234694875 | chr2 |
| ENr132 | 112354915 | chr13 |
| ENr132 | 112414315 | chr13 |
| ENr132 | 112427415 | chr13 |
| ENr132 | 112575215 | chr13 |
| ENr132 | 112786815 | chr13 |
| ENr133 | 39252317 | chr21 |
| ENr133 | 39274517 | chr21 |
| ENr133 | 39280817 | chr21 |
| ENr133 | 39287317 | chr21 |
| ENr133 | 39300417 | chr21 |
| ENr133 | 39309117 | chr21 |
| ENr133 | 39315817 | chr21 |
| ENr133 | 39341517 | chr21 |
| ENr133 | 39388817 | chr21 |
| ENr133 | 39408917 | chr21 |
| ENr133 | 39419617 | chr21 |
| ENr133 | 39431917 | chr21 |
| ENr133 | 39469317 | chr21 |
| ENr212 | 141959801 | chr5 |
| ENr212 | 142004601 | chr5 |
| ENr212 | 142058001 | chr5 |
| ENr212 | 142170401 | chr5 |
| ENr212 | 142177101 | chr5 |
| ENr212 | 142180301 | chr5 |
| ENr212 | 142185001 | chr5 |
| ENr212 | 142186801 | chr5 |
| ENr212 | 142188801 | chr5 |
| ENr212 | 142190701 | chr5 |
| ENr212 | 142199801 | chr5 |
| ENr212 | 142217801 | chr5 |
| ENr212 | 142234501 | chr5 |
| ENr212 | 142242801 | chr5 |
| ENr212 | 142285501 | chr5 |
| ENr212 | 142340901 | chr5 |
| ENr212 | 142362501 | chr5 |
| ENr212 | 142369601 | chr5 |
| ENr213 | 23755982 | chr18 |
| ENr213 | 23798982 | chr18 |
| ENr213 | 23830682 | chr18 |
| ENr213 | 23865682 | chr18 |
| ENr213 | 23873782 | chr18 |
| ENr213 | 23898282 | chr18 |
| ENr213 | 23910082 | chr18 |
| ENr213 | 23921482 | chr18 |
| ENr213 | 23943782 | chr18 |
| ENr213 | 23945882 | chr18 |
| ENr213 | 23947582 | chr18 |
| ENr213 | 23949582 | chr18 |
| ENr213 | 23958482 | chr18 |
| ENr213 | 23962082 | chr18 |
| ENr213 | 23994782 | chr18 |
| ENr213 | 23996582 | chr18 |
| ENr213 | 24005182 | chr18 |
| ENr213 | 24017382 | chr18 |
| ENr213 | 24038182 | chr18 |
| ENr221 | 55901357 | chr5 |
| ENr221 | 55939557 | chr5 |
| ENr221 | 55947757 | chr5 |
| ENr221 | 55955757 | chr5 |
| ENr221 | 55969357 | chr5 |
| ENr221 | 55981457 | chr5 |
| ENr221 | 56029757 | chr5 |
| ENr221 | 56048657 | chr5 |
| ENr221 | 56065557 | chr5 |
| ENr221 | 56336657 | chr5 |
| ENr221 | 56363157 | chr5 |
| ENr222 | 132226090 | chr6 |
| ENr222 | 132300690 | chr6 |
| ENr222 | 132315890 | chr6 |
| ENr222 | 132317590 | chr6 |
| ENr222 | 132343890 | chr6 |
| ENr222 | 132416990 | chr6 |
| ENr222 | 132426790 | chr6 |
| ENr222 | 132448190 | chr6 |
| ENr222 | 132485990 | chr6 |
| ENr222 | 132494990 | chr6 |
| ENr222 | 132553290 | chr6 |
| ENr222 | 132562090 | chr6 |
| ENr222 | 132599190 | chr6 |
| ENr222 | 132633790 | chr6 |
| ENr222 | 132696890 | chr6 |
| ENr223 | 73798003 | chr6 |
| ENr223 | 73829203 | chr6 |
| ENr223 | 73846303 | chr6 |
| ENr231 | 148098184 | chr1 |
| ENr231 | 148156884 | chr1 |
| ENr231 | 148280784 | chr1 |
| ENr231 | 148298284 | chr1 |
| ENr231 | 148321484 | chr1 |
| ENr231 | 148334484 | chr1 |
| ENr231 | 148354884 | chr1 |
| ENr231 | 148360684 | chr1 |
| ENr231 | 148382384 | chr1 |
| ENr232 | 128982106 | chr9 |
| ENr232 | 128984206 | chr9 |
| ENr232 | 129009706 | chr9 |
| ENr232 | 129079106 | chr9 |
| ENr232 | 129100406 | chr9 |
| ENr232 | 129120506 | chr9 |
| ENr232 | 129177106 | chr9 |
| ENr232 | 129194206 | chr9 |
| ENr232 | 129249006 | chr9 |
| ENr232 | 129255506 | chr9 |
| ENr233 | 41588939 | chr15 |
| ENr233 | 41595439 | chr15 |
| ENr233 | 41682039 | chr15 |
| ENr233 | 41801939 | chr15 |
| ENr233 | 41992139 | chr15 |
| ENr311 | 52994826 | chr14 |
| ENr311 | 53078726 | chr14 |
| ENr311 | 53144926 | chr14 |
| ENr311 | 53252126 | chr14 |
| ENr311 | 53278826 | chr14 |
| ENr311 | 53327526 | chr14 |
| ENr311 | 53330026 | chr14 |
| ENr311 | 53344026 | chr14 |
| ENr311 | 53378926 | chr14 |
| ENr311 | 53388026 | chr14 |
| ENr311 | 53417526 | chr14 |
| ENr311 | 53430726 | chr14 |
| ENr312 | 130798248 | chr11 |
| ENr312 | 130805648 | chr11 |
| ENr321 | 118913771 | chr8 |
| ENr321 | 118929271 | chr8 |
| ENr321 | 118944071 | chr8 |
| ENr321 | 119018971 | chr8 |
| ENr321 | 119029471 | chr8 |
| ENr321 | 119057371 | chr8 |
| ENr321 | 119059771 | chr8 |
| ENr321 | 119081271 | chr8 |
| ENr321 | 119091871 | chr8 |
| ENr321 | 119099671 | chr8 |
| ENr321 | 119107171 | chr8 |
| ENr321 | 119113271 | chr8 |
| ENr321 | 119130171 | chr8 |
| ENr321 | 119160871 | chr8 |
| ENr321 | 119169071 | chr8 |
| ENr321 | 119175271 | chr8 |
| ENr321 | 119181071 | chr8 |
| ENr321 | 119291271 | chr8 |
| ENr322 | 98489974 | chr14 |
| ENr322 | 98491674 | chr14 |
| ENr322 | 98572474 | chr14 |
| ENr322 | 98635574 | chr14 |
| ENr322 | 98789374 | chr14 |
| ENr322 | 98808674 | chr14 |
| ENr322 | 98915974 | chr14 |
| ENr322 | 98917974 | chr14 |
| ENr323 | 108546047 | chr6 |
| ENr323 | 108561947 | chr6 |
| ENr324 | 122662300 | chrX |
| ENr324 | 122684300 | chrX |
| ENr324 | 122690100 | chrX |
| ENr324 | 122728600 | chrX |
| ENr324 | 122765000 | chrX |
| ENr324 | 122782500 | chrX |
| ENr324 | 122830700 | chrX |
| ENr324 | 122838400 | chrX |
| ENr324 | 122840300 | chrX |
| ENr331 | 220132001 | chr2 |
| ENr331 | 220136601 | chr2 |
| ENr331 | 220143701 | chr2 |
| ENr331 | 220151001 | chr2 |
| ENr331 | 220201201 | chr2 |
| ENr331 | 220211601 | chr2 |
| ENr331 | 220335901 | chr2 |
| ENr331 | 220376101 | chr2 |
| ENr331 | 220379401 | chr2 |
| ENr331 | 220397601 | chr2 |
| ENr331 | 220419301 | chr2 |
| ENr332 | 63972739 | chr11 |
| ENr332 | 64090939 | chr11 |
| ENr332 | 64199539 | chr11 |
| ENr332 | 64367539 | chr11 |
| ENr332 | 64379839 | chr11 |
| ENr332 | 64393639 | chr11 |
| ENr333 | 33315479 | chr20 |
| ENr333 | 33357079 | chr20 |
| ENr333 | 33363379 | chr20 |
| ENr333 | 33370179 | chr20 |
| ENr333 | 33378779 | chr20 |
| ENr333 | 33408679 | chr20 |
| ENr333 | 33438779 | chr20 |
| ENr333 | 33518979 | chr20 |
| ENr333 | 33669179 | chr20 |
| ENr333 | 33784179 | chr20 |
| ENr334 | 41505745 | chr6 |
| ENr334 | 41520245 | chr6 |
| ENr334 | 41540745 | chr6 |
| ENr334 | 41547545 | chr6 |
| ENr334 | 41565045 | chr6 |
| ENr334 | 41579445 | chr6 |
| ENr334 | 41581145 | chr6 |
| ENr334 | 41607245 | chr6 |
| ENr334 | 41654545 | chr6 |
| ENr334 | 41701445 | chr6 |
| ENr334 | 41774545 | chr6 |
| ENr334 | 41781945 | chr6 |
| ENr334 | 41788545 | chr6 |
| ENr334 | 41790845 | chr6 |
| ENr334 | 41799145 | chr6 |
| ENr334 | 41807745 | chr6 |
| ENr334 | 41843245 | chr6 |

TABLE 3

| | | |
|---|---|---|
| ENr122 | 59421751 | chr18 |
| ENr122 | 59649551 | chr18 |
| ENr122 | 59699651 | chr18 |
| ENr122 | 59706351 | chr18 |
| ENr122 | 59713651 | chr18 |
| ENr122 | 59726051 | chr18 |
| ENr122 | 59794451 | chr18 |
| ENr122 | 59799351 | chr18 |
| ENr122 | 59846351 | chr18 |
| ENr211 | 25817078 | chr16 |
| ENr211 | 25885678 | chr16 |
| ENr211 | 25887378 | chr16 |
| ENr132 | 112413315 | chr13 |
| ENr132 | 112427415 | chr13 |
| ENr132 | 112436215 | chr13 |
| ENr132 | 112470615 | chr13 |
| ENr132 | 112482915 | chr13 |
| ENr132 | 112506015 | chr13 |
| ENr132 | 112530615 | chr13 |
| ENr132 | 112552515 | chr13 |
| ENr132 | 112575315 | chr13 |
| ENr334 | 41419845 | chr6 |
| ENr334 | 41516345 | chr6 |
| ENr334 | 41550145 | chr6 |
| ENr334 | 41563645 | chr6 |
| ENr334 | 41570345 | chr6 |
| ENr334 | 41607545 | chr6 |
| ENr334 | 41614345 | chr6 |
| ENr334 | 41791045 | chr6 |
| ENm002 | 131383464 | chr5 |
| ENm002 | 131465864 | chr5 |
| ENm002 | 131542764 | chr5 |
| ENm002 | 131567564 | chr5 |
| ENm002 | 131632764 | chr5 |
| ENm002 | 131722264 | chr5 |
| ENm002 | 131751064 | chr5 |
| ENm002 | 131758564 | chr5 |
| ENm002 | 131784464 | chr5 |
| ENm002 | 131792764 | chr5 |
| ENm002 | 131801264 | chr5 |
| ENm002 | 131809064 | chr5 |
| ENm002 | 131820964 | chr5 |
| ENm002 | 131830064 | chr5 |
| ENm002 | 131836264 | chr5 |
| ENm002 | 131842964 | chr5 |
| ENm002 | 131889764 | chr5 |
| ENm002 | 131929564 | chr5 |
| ENm002 | 131993564 | chr5 |
| ENm002 | 132004864 | chr5 |
| ENm002 | 132025164 | chr5 |
| ENm002 | 132026964 | chr5 |
| ENm002 | 132037864 | chr5 |
| ENm002 | 132052364 | chr5 |
| ENm002 | 132115364 | chr5 |
| ENm002 | 132148964 | chr5 |
| ENm010 | 26844711 | chr7 |
| ENm010 | 26896711 | chr7 |
| ENm010 | 26947411 | chr7 |
| ENr223 | 73846303 | chr6 |
| ENr223 | 73853403 | chr6 |
| ENr223 | 73890503 | chr6 |
| ENr223 | 73912303 | chr6 |
| ENr223 | 73943703 | chr6 |
| ENr223 | 74095703 | chr6 |
| ENr223 | 74237603 | chr6 |
| ENr223 | 74276203 | chr6 |
| ENm009 | 5255746 | chr11 |
| ENm009 | 5321746 | chr11 |
| ENm009 | 5346046 | chr11 |
| ENm009 | 5527246 | chr11 |
| ENm009 | 5609946 | chr11 |
| ENm009 | 5685246 | chr11 |
| ENr331 | 220332901 | chr2 |
| ENr331 | 220353101 | chr2 |
| ENr331 | 220376001 | chr2 |
| ENr331 | 220535401 | chr2 |
| ENr331 | 220591901 | chr2 |
| ENr322 | 98822974 | chr14 |
| ENr322 | 98926174 | chr14 |
| ENr322 | 98948774 | chr14 |
| ENr133 | 39273617 | chr21 |
| ENr133 | 39279317 | chr21 |
| ENr133 | 39483317 | chr21 |
| ENr133 | 39560017 | chr21 |
| ENr133 | 39668317 | chr21 |
| ENr131 | 234283575 | chr2 |
| ENr131 | 234346575 | chr2 |
| ENm004 | 30167058 | chr22 |
| ENm004 | 30172058 | chr22 |
| ENm004 | 30198358 | chr22 |
| ENm004 | 30241158 | chr22 |
| ENm004 | 30257058 | chr22 |
| ENm004 | 30270658 | chr22 |
| ENm004 | 30276758 | chr22 |
| ENm004 | 30301758 | chr22 |
| ENm004 | 30307358 | chr22 |
| ENm004 | 30336758 | chr22 |
| ENm004 | 30367858 | chr22 |
| ENm004 | 30373258 | chr22 |
| ENm004 | 30455158 | chr22 |
| ENm004 | 30489658 | chr22 |
| ENm004 | 30510958 | chr22 |
| ENm004 | 30550058 | chr22 |
| ENm004 | 30567058 | chr22 |
| ENm004 | 30637958 | chr22 |
| ENm004 | 30644358 | chr22 |
| ENm004 | 30672458 | chr22 |
| ENm004 | 30771658 | chr22 |
| ENm004 | 30861458 | chr22 |
| ENm004 | 30870758 | chr22 |
| ENm004 | 31138558 | chr22 |
| ENm004 | 31201958 | chr22 |
| ENm004 | 31351558 | chr22 |
| ENm013 | 89453490 | chr7 |
| ENm013 | 89513690 | chr7 |
| ENm013 | 89699390 | chr7 |
| ENm013 | 89807690 | chr7 |
| ENm013 | 89879090 | chr7 |
| ENm013 | 89886390 | chr7 |
| ENm013 | 89895490 | chr7 |
| ENm013 | 89929690 | chr7 |
| ENm013 | 89935890 | chr7 |
| ENm013 | 89943590 | chr7 |
| ENm013 | 89975090 | chr7 |
| ENm013 | 89989690 | chr7 |
| ENm013 | 90000290 | chr7 |
| ENm013 | 90011590 | chr7 |
| ENm013 | 90031290 | chr7 |
| ENm013 | 90038990 | chr7 |
| ENm013 | 90048090 | chr7 |
| ENm013 | 90090890 | chr7 |
| ENm013 | 90127190 | chr7 |
| ENm013 | 90131990 | chr7 |
| ENm013 | 90166190 | chr7 |
| ENm013 | 90206090 | chr7 |
| ENm013 | 90439090 | chr7 |
| ENr312 | 131020548 | chr11 |
| ENr312 | 131031948 | chr11 |
| ENr212 | 142160701 | chr5 |
| ENr212 | 142167801 | chr5 |
| ENr212 | 142205001 | chr5 |
| ENr212 | 142284701 | chr5 |
| ENr212 | 142319801 | chr5 |
| ENr212 | 142331501 | chr5 |
| ENr212 | 142363501 | chr5 |
| ENr212 | 142369201 | chr5 |
| ENr323 | 108419447 | chr6 |
| ENr323 | 108631647 | chr6 |
| ENr323 | 108679547 | chr6 |
| ENr323 | 108712447 | chr6 |
| ENr323 | 108769547 | chr6 |
| ENr323 | 108776647 | chr6 |
| ENm012 | 113648834 | chr7 |
| ENm012 | 113789534 | chr7 |
| ENm012 | 113864634 | chr7 |
| ENm012 | 113895434 | chr7 |
| ENm012 | 113934534 | chr7 |
| ENm012 | 113955534 | chr7 |
| ENm012 | 113992434 | chr7 |
| ENm012 | 114035534 | chr7 |
| ENm012 | 114068734 | chr7 |
| ENm012 | 114099534 | chr7 |
| ENm012 | 114151534 | chr7 |
| ENm012 | 114169134 | chr7 |
| ENm012 | 114175234 | chr7 |
| ENm012 | 114182434 | chr7 |
| ENm012 | 114191934 | chr7 |
| ENm012 | 114193834 | chr7 |
| ENm012 | 114205434 | chr7 |
| ENm012 | 114214534 | chr7 |
| ENm012 | 114242634 | chr7 |
| ENm012 | 114300134 | chr7 |
| ENm012 | 114370634 | chr7 |
| ENr233 | 41718139 | chr15 |
| ENr233 | 41814739 | chr15 |
| ENr233 | 41888839 | chr15 |
| ENm006 | 152665295 | chrX |
| ENm006 | 152687995 | chrX |
| ENm006 | 152770695 | chrX |
| ENm006 | 152827495 | chrX |
| ENm006 | 152870795 | chrX |
| ENm006 | 153061695 | chrX |
| ENm006 | 153070795 | chrX |
| ENm006 | 153083395 | chrX |
| ENm006 | 153168495 | chrX |
| ENm006 | 153318895 | chrX |
| ENm006 | 153504795 | chrX |
| ENm006 | 153510995 | chrX |
| ENm006 | 153526195 | chrX |
| ENm006 | 153575495 | chrX |
| ENm006 | 153588595 | chrX |
| ENm006 | 153614695 | chrX |
| ENm006 | 153620195 | chrX |
| ENm006 | 153694495 | chrX |
| ENm006 | 153784595 | chrX |
| ENm006 | 153844795 | chrX |
| ENr213 | 23866782 | chr18 |
| ENr213 | 23868382 | chr18 |
| ENr213 | 23897982 | chr18 |
| ENr213 | 23905482 | chr18 |
| ENr213 | 23913082 | chr18 |
| ENr213 | 23919882 | chr18 |
| ENr213 | 23928882 | chr18 |
| ENr213 | 23958682 | chr18 |
| ENr213 | 23965182 | chr18 |
| ENr213 | 23969582 | chr18 |
| ENr213 | 23987782 | chr18 |
| ENr213 | 23995682 | chr18 |
| ENr213 | 24003082 | chr18 |
| ENm008 | 14951 | chr16 |
| ENm008 | 25451 | chr16 |
| ENm008 | 28151 | chr16 |
| ENm008 | 74651 | chr16 |
| ENm008 | 231451 | chr16 |
| ENm008 | 315151 | chr16 |
| ENm008 | 432651 | chr16 |
| ENm008 | 443651 | chr16 |
| ENr222 | 132447790 | chr6 |
| ENr222 | 132631790 | chr6 |
| ENr321 | 118962971 | chr8 |
| ENr321 | 118976971 | chr8 |
| ENr321 | 118988071 | chr8 |
| ENr321 | 118998971 | chr8 |
| ENr321 | 119002871 | chr8 |
| ENr321 | 119018671 | chr8 |
| ENr321 | 119038371 | chr8 |
| ENr321 | 119052171 | chr8 |
| ENr321 | 119060871 | chr8 |
| ENr321 | 119070671 | chr8 |
| ENr321 | 119080871 | chr8 |
| ENr321 | 119087371 | chr8 |
| ENr321 | 119101071 | chr8 |
| ENr321 | 119118571 | chr8 |
| ENr321 | 119142271 | chr8 |
| ENr321 | 119150071 | chr8 |
| ENr321 | 119171171 | chr8 |
| ENr321 | 119181271 | chr8 |
| ENr321 | 119277471 | chr8 |
| ENr321 | 119340371 | chr8 |
| ENr321 | 119362571 | chr8 |
| ENm005 | 32945087 | chr21 |
| ENm005 | 33006187 | chr21 |
| ENm005 | 33107887 | chr21 |
| ENm005 | 33209187 | chr21 |
| ENm005 | 33226387 | chr21 |
| ENm005 | 33373187 | chr21 |
| ENm005 | 33498487 | chr21 |
| ENm005 | 33508087 | chr21 |
| ENm005 | 33509687 | chr21 |
| ENm005 | 33532587 | chr21 |
| ENm005 | 33590287 | chr21 |
| ENm005 | 33594287 | chr21 |
| ENm005 | 33603287 | chr21 |
| ENm005 | 33633787 | chr21 |
| ENm005 | 33655087 | chr21 |
| ENm005 | 33668987 | chr21 |
| ENm005 | 33675887 | chr21 |
| ENm005 | 33688987 | chr21 |
| ENm005 | 33706987 | chr21 |
| ENm005 | 33727287 | chr21 |
| ENm005 | 33737987 | chr21 |
| ENm005 | 33980087 | chr21 |
| ENm005 | 34029587 | chr21 |
| ENm005 | 34226487 | chr21 |
| ENm005 | 34242487 | chr21 |
| ENm005 | 34244287 | chr21 |
| ENm005 | 34263287 | chr21 |
| ENm005 | 34269687 | chr21 |
| ENm005 | 34278287 | chr21 |
| ENm005 | 34314087 | chr21 |
| ENm005 | 34325487 | chr21 |
| ENm005 | 34340987 | chr21 |
| ENr311 | 53052926 | chr14 |
| ENr311 | 53069526 | chr14 |
| ENr311 | 53081826 | chr14 |
| ENr311 | 53107926 | chr14 |
| ENr311 | 53144226 | chr14 |
| ENr311 | 53150026 | chr14 |
| ENr311 | 53157326 | chr14 |
| ENr311 | 53191626 | chr14 |
| ENr311 | 53234026 | chr14 |
| ENr311 | 53236226 | chr14 |
| ENr311 | 53377626 | chr14 |
| ENr311 | 53417526 | chr14 |
| ENr311 | 53426126 | chr14 |
| ENr311 | 53427826 | chr14 |
| ENr311 | 53431126 | chr14 |
| ENr111 | 29592766 | chr13 |
| ENr111 | 29614066 | chr13 |
| ENr111 | 29619466 | chr13 |
| ENr111 | 29628866 | chr13 |
| ENr111 | 29630666 | chr13 |
| ENr111 | 29649966 | chr13 |
| ENr111 | 29665766 | chr13 |
| ENr111 | 29713666 | chr13 |
| ENr111 | 29729666 | chr13 |
| ENr111 | 29786466 | chr13 |
| ENr111 | 29805366 | chr13 |
| ENr111 | 29819266 | chr13 |
| ENr111 | 29843466 | chr13 |
| ENr111 | 29880466 | chr13 |
| ENr111 | 29903566 | chr13 |
| ENr231 | 148023084 | chr1 |
| ENr231 | 148224284 | chr1 |
| ENr231 | 148230384 | chr1 |
| ENr231 | 148251184 | chr1 |
| ENr231 | 148259084 | chr1 |
| ENr231 | 148260784 | chr1 |
| ENr231 | 148280184 | chr1 |
| ENr231 | 148289284 | chr1 |
| ENr231 | 148360784 | chr1 |
| ENr231 | 148405484 | chr1 |
| ENm011 | 1822742 | chr11 |
| ENr123 | 38817927 | chr12 |
| ENr123 | 38838527 | chr12 |
| ENr123 | 38849827 | chr12 |
| ENr123 | 38876127 | chr12 |
| ENr123 | 38889227 | chr12 |
| ENr123 | 38912127 | chr12 |
| ENr123 | 38928527 | chr12 |
| ENr123 | 38942927 | chr12 |
| ENr123 | 38994727 | chr12 |
| ENr333 | 33364179 | chr20 |
| ENr333 | 33553779 | chr20 |
| ENr333 | 33557079 | chr20 |
| ENr333 | 33658179 | chr20 |
| ENr333 | 33663279 | chr20 |
| ENr333 | 33764079 | chr20 |
| ENr333 | 33785479 | chr20 |
| ENr232 | 128863306 | chr9 |
| ENr232 | 128973306 | chr9 |
| ENr232 | 128983606 | chr9 |
| ENr232 | 128990806 | chr9 |
| ENr232 | 129027406 | chr9 |
| ENr232 | 129063506 | chr9 |
| ENr232 | 129112606 | chr9 |
| ENm003 | 116109866 | chr11 |
| ENm003 | 116228966 | chr11 |
| ENm003 | 116303966 | chr11 |
| ENm003 | 116306066 | chr11 |
| ENm003 | 116362866 | chr11 |
| ENm003 | 116382266 | chr11 |
| ENm003 | 116396866 | chr11 |
| ENm003 | 116399766 | chr11 |
| ENm003 | 116414966 | chr11 |
| ENm003 | 116420466 | chr11 |
| ENm003 | 116439166 | chr11 |
| ENm003 | 116450466 | chr11 |
| ENm003 | 116452766 | chr11 |
| ENr332 | 63972739 | chr11 |
| ENr332 | 64198139 | chr11 |
| ENr332 | 64239139 | chr11 |
| ENr332 | 64288339 | chr11 |
| ENr332 | 64296039 | chr11 |
| ENr332 | 64376639 | chr11 |
| ENr332 | 64383339 | chr11 |
| ENr332 | 64387039 | chr11 |
| ENr332 | 64393439 | chr11 |
| ENr332 | 64411939 | chr11 |
| ENr221 | 55920757 | chr5 |
| ENr221 | 55971557 | chr5 |
| ENr221 | 55990857 | chr5 |
| ENr221 | 56001757 | chr5 |
| ENr221 | 56008357 | chr5 |
| ENr221 | 56017757 | chr5 |
| ENr221 | 56024057 | chr5 |
| ENr221 | 56068157 | chr5 |
| ENr221 | 56095357 | chr5 |
| ENr221 | 56161657 | chr5 |
| ENr221 | 56170657 | chr5 |
| ENr221 | 56184157 | chr5 |
| ENr221 | 56317257 | chr5 |
| ENr221 | 56362457 | chr5 |
| ENm014 | 125681057 | chr7 |
| ENm014 | 125682657 | chr7 |
| ENm014 | 125803457 | chr7 |
| ENm014 | 125892857 | chr7 |
| ENm014 | 125935357 | chr7 |
| ENm014 | 125953557 | chr7 |
| ENm014 | 126183357 | chr7 |
| ENm014 | 126598857 | chr7 |
| ENm014 | 126616857 | chr7 |
| ENm014 | 126638357 | chr7 |
| ENm014 | 126648357 | chr7 |
| ENm001 | 115452922 | chr7 |
| ENm001 | 115456522 | chr7 |
| ENm001 | 115464822 | chr7 |
| ENm001 | 115495822 | chr7 |
| ENm001 | 115550722 | chr7 |
| ENm001 | 115746122 | chr7 |
| ENm001 | 115776822 | chr7 |
| ENm001 | 115782422 | chr7 |
| ENm001 | 115808522 | chr7 |
| ENm001 | 115817522 | chr7 |
| ENm001 | 115866322 | chr7 |
| ENm001 | 116106622 | chr7 |
| ENm001 | 116198022 | chr7 |
| ENm001 | 116213022 | chr7 |
| ENm001 | 116220822 | chr7 |
| ENm001 | 116244322 | chr7 |
| ENm001 | 116257922 | chr7 |
| ENm001 | 116274722 | chr7 |
| ENm001 | 116280822 | chr7 |
| ENm001 | 116303022 | chr7 |
| ENm001 | 116321122 | chr7 |
| ENm001 | 116329922 | chr7 |
| ENm001 | 116345022 | chr7 |
| ENm001 | 116358622 | chr7 |
| ENm001 | 116449322 | chr7 |
| ENm001 | 116464522 | chr7 |
| ENm001 | 116474922 | chr7 |
| ENm001 | 116484622 | chr7 |
| ENm001 | 116493522 | chr7 |
| ENm001 | 116504222 | chr7 |
| ENm001 | 116657922 | chr7 |
| ENm001 | 116669222 | chr7 |
| ENm001 | 116797922 | chr7 |
| ENm001 | 116822622 | chr7 |
| ENm001 | 116864522 | chr7 |
| ENm001 | 116964922 | chr7 |
| ENm001 | 117008922 | chr7 |
| ENm001 | 117016722 | chr7 |
| ENm001 | 117026022 | chr7 |
| ENm001 | 117274122 | chr7 |
| ENm007 | 59047935 | chr19 |
| ENm007 | 59404935 | chr19 |
| ENm007 | 59467735 | chr19 |
| ENm007 | 59484935 | chr19 |
| ENm007 | 59548935 | chr19 |
| ENm007 | 59565235 | chr19 |
| ENm007 | 59574135 | chr19 |
| ENm007 | 59578735 | chr19 |
| ENm007 | 59592135 | chr19 |
| ENm007 | 59694135 | chr19 |
| ENm007 | 59701435 | chr19 |
| ENm007 | 59710335 | chr19 |
| ENm007 | 59723035 | chr19 |
| ENm007 | 59724835 | chr19 |
| ENm007 | 59735835 | chr19 |
| ENm007 | 59754435 | chr19 |
| ENm007 | 59776635 | chr19 |
| ENm007 | 59797035 | chr19 |
| ENm007 | 59810035 | chr19 |
| ENm007 | 59828635 | chr19 |
| ENm007 | 59835735 | chr19 |
| ENm007 | 59858035 | chr19 |
| ENm007 | 59864935 | chr19 |
| ENr324 | 122631600 | chrX |
| ENr324 | 122645400 | chrX |
| ENr324 | 122659200 | chrX |
| ENr324 | 122674100 | chrX |
| ENr324 | 122690100 | chrX |
| ENr324 | 122729800 | chrX |
| ENr324 | 122731500 | chrX |
| ENr324 | 122738000 | chrX |
| ENr324 | 122830200 | chrX |
| ENr324 | 122832300 | chrX |
| ENr324 | 122838600 | chrX |
| ENr324 | 122844500 | chrX |
| ENr324 | 122850300 | chrX |
| ENr324 | 122868600 | chrX |
| ENr324 | 122889100 | chrX |
| ENr324 | 122923500 | chrX |

TABLE 4

| | | |
|---|---|---|
| ENm001 | 115465022 | chr7 |
| ENm001 | 115588922 | chr7 |
| ENm001 | 115652722 | chr7 |
| ENm001 | 115673322 | chr7 |
| ENm001 | 115699922 | chr7 |
| ENm001 | 115725522 | chr7 |
| ENm001 | 115746422 | chr7 |
| ENm001 | 116104822 | chr7 |
| ENm001 | 116111522 | chr7 |
| ENm001 | 116205822 | chr7 |
| ENm001 | 116212422 | chr7 |
| ENm001 | 116244422 | chr7 |
| ENm001 | 116255422 | chr7 |
| ENm001 | 116260322 | chr7 |
| ENm001 | 116268922 | chr7 |
| ENm001 | 116280322 | chr7 |
| ENm001 | 116286822 | chr7 |
| ENm001 | 116321122 | chr7 |
| ENm001 | 116347022 | chr7 |
| ENm001 | 116443622 | chr7 |
| ENm001 | 116464222 | chr7 |
| ENm001 | 116514222 | chr7 |
| ENm001 | 117007922 | chr7 |
| ENm001 | 117026122 | chr7 |
| ENm002 | 131358964 | chr5 |
| ENm002 | 131434664 | chr5 |
| ENm002 | 131450064 | chr5 |
| ENm002 | 131462064 | chr5 |
| ENm002 | 131467264 | chr5 |
| ENm002 | 131478364 | chr5 |
| ENm002 | 131542464 | chr5 |
| ENm002 | 131623964 | chr5 |
| ENm002 | 131627664 | chr5 |
| ENm002 | 131637364 | chr5 |
| ENm002 | 131642564 | chr5 |
| ENm002 | 131665464 | chr5 |
| ENm002 | 131671664 | chr5 |
| ENm002 | 131681064 | chr5 |
| ENm002 | 131687164 | chr5 |
| ENm002 | 131707964 | chr5 |
| ENm002 | 131751164 | chr5 |
| ENm002 | 131785964 | chr5 |
| ENm002 | 131788164 | chr5 |
| ENm002 | 131801064 | chr5 |
| ENm002 | 131822764 | chr5 |
| ENm002 | 131830464 | chr5 |
| ENm002 | 131890564 | chr5 |
| ENm002 | 132026864 | chr5 |
| ENm002 | 132029264 | chr5 |
| ENm002 | 132037364 | chr5 |
| ENm002 | 132049364 | chr5 |
| ENm002 | 132052664 | chr5 |
| ENm002 | 132137864 | chr5 |
| ENm002 | 132150464 | chr5 |
| ENm002 | 132152764 | chr5 |
| ENm002 | 132155064 | chr5 |
| ENm002 | 132171464 | chr5 |
| ENm002 | 132184064 | chr5 |
| ENm002 | 132236364 | chr5 |
| ENm003 | 116202466 | chr11 |
| ENm003 | 116228866 | chr11 |
| ENm003 | 116236866 | chr11 |
| ENm003 | 116307066 | chr11 |
| ENm003 | 116334066 | chr11 |
| ENm003 | 116346366 | chr11 |
| ENm003 | 116379466 | chr11 |
| ENm003 | 116386666 | chr11 |
| ENm003 | 116396566 | chr11 |
| ENm003 | 116398566 | chr11 |
| ENm003 | 116413766 | chr11 |
| ENm003 | 116447466 | chr11 |
| ENm004 | 30257158 | chr22 |
| ENm004 | 30323558 | chr22 |
| ENm004 | 30346558 | chr22 |
| ENm004 | 30348958 | chr22 |
| ENm004 | 30373358 | chr22 |
| ENm004 | 30391758 | chr22 |
| ENm004 | 30485658 | chr22 |
| ENm004 | 30495758 | chr22 |
| ENm004 | 30517958 | chr22 |
| ENm004 | 30550558 | chr22 |
| ENm004 | 30577858 | chr22 |
| ENm004 | 30588158 | chr22 |
| ENm004 | 30596958 | chr22 |
| ENm004 | 30602658 | chr22 |
| ENm004 | 30611158 | chr22 |
| ENm004 | 30615458 | chr22 |
| ENm004 | 30623058 | chr22 |
| ENm004 | 30631558 | chr22 |
| ENm004 | 30635658 | chr22 |
| ENm004 | 30643758 | chr22 |
| ENm004 | 30649658 | chr22 |
| ENm004 | 30657658 | chr22 |
| ENm004 | 30672258 | chr22 |
| ENm004 | 30771058 | chr22 |
| ENm004 | 31202158 | chr22 |
| ENm004 | 31253158 | chr22 |
| ENm004 | 31260358 | chr22 |
| ENm004 | 31267058 | chr22 |
| ENm004 | 31277458 | chr22 |
| ENm004 | 31291458 | chr22 |
| ENm004 | 31295258 | chr22 |
| ENm004 | 31307558 | chr22 |
| ENm004 | 31343058 | chr22 |
| ENm004 | 31349858 | chr22 |
| ENm004 | 31371358 | chr22 |
| ENm004 | 31561858 | chr22 |
| ENm004 | 31573358 | chr22 |
| ENm004 | 31594958 | chr22 |
| ENm004 | 31602258 | chr22 |
| ENm004 | 31631758 | chr22 |
| ENm005 | 32722287 | chr21 |
| ENm005 | 32810387 | chr21 |
| ENm005 | 32818187 | chr21 |
| ENm005 | 32840487 | chr21 |
| ENm005 | 32849787 | chr21 |
| ENm005 | 32881287 | chr21 |
| ENm005 | 33004787 | chr21 |
| ENm005 | 33497887 | chr21 |
| ENm005 | 33509787 | chr21 |
| ENm005 | 33525987 | chr21 |
| ENm005 | 33543487 | chr21 |
| ENm005 | 33577187 | chr21 |
| ENm005 | 33595487 | chr21 |
| ENm005 | 33599087 | chr21 |
| ENm005 | 33677487 | chr21 |
| ENm005 | 33699787 | chr21 |
| ENm005 | 33729187 | chr21 |
| ENm005 | 33805687 | chr21 |
| ENm005 | 33911887 | chr21 |
| ENm005 | 33950987 | chr21 |
| ENm005 | 34055587 | chr21 |
| ENm005 | 34111887 | chr21 |
| ENm005 | 34190487 | chr21 |
| ENm005 | 34196387 | chr21 |
| ENm005 | 34218187 | chr21 |
| ENm005 | 34241887 | chr21 |
| ENm005 | 34261787 | chr21 |
| ENm005 | 34269087 | chr21 |
| ENm005 | 34281887 | chr21 |
| ENm005 | 34287587 | chr21 |
| ENm005 | 34293387 | chr21 |
| ENm005 | 34301287 | chr21 |
| ENm005 | 34318287 | chr21 |
| ENm005 | 34325787 | chr21 |
| ENm006 | 152687895 | chrX |
| ENm006 | 152727595 | chrX |
| ENm006 | 152771595 | chrX |
| ENm006 | 152869195 | chrX |
| ENm006 | 152878195 | chrX |
| ENm006 | 152880295 | chrX |
| ENm006 | 152908795 | chrX |
| ENm006 | 152940095 | chrX |
| ENm006 | 152951295 | chrX |
| ENm006 | 152960295 | chrX |
| ENm006 | 152977195 | chrX |
| ENm006 | 152988295 | chrX |
| ENm006 | 152997495 | chrX |
| ENm006 | 153014095 | chrX |
| ENm006 | 153025295 | chrX |
| ENm006 | 153035295 | chrX |
| ENm006 | 153179495 | chrX |
| ENm006 | 153275795 | chrX |
| ENm006 | 153333895 | chrX |
| ENm006 | 153510095 | chrX |
| ENm006 | 153522995 | chrX |
| ENm006 | 153526695 | chrX |
| ENm006 | 153529495 | chrX |
| ENm006 | 153544595 | chrX |
| ENm006 | 153552295 | chrX |
| ENm006 | 153577495 | chrX |
| ENm006 | 153583895 | chrX |
| ENm006 | 153585595 | chrX |
| ENm006 | 153614695 | chrX |
| ENm006 | 153621295 | chrX |
| ENm006 | 153627795 | chrX |
| ENm006 | 153629995 | chrX |
| ENm006 | 153790795 | chrX |
| ENm006 | 153798195 | chrX |
| ENm006 | 153814295 | chrX |
| ENm006 | 153839595 | chrX |
| ENm006 | 153879495 | chrX |
| ENm006 | 153939795 | chrX |
| ENm007 | 59038335 | chr19 |
| ENm007 | 59084035 | chr19 |
| ENm007 | 59405735 | chr19 |
| ENm007 | 59419635 | chr19 |
| ENm007 | 59438935 | chr19 |
| ENm007 | 59722935 | chr19 |
| ENm007 | 59776035 | chr19 |
| ENm007 | 59858135 | chr19 |
| ENm007 | 59898735 | chr19 |
| ENm008 | 66551 | chr16 |
| ENm008 | 95251 | chr16 |
| ENm008 | 103651 | chr16 |
| ENm008 | 109951 | chr16 |
| ENm008 | 112151 | chr16 |
| ENm008 | 125851 | chr16 |
| ENm008 | 133851 | chr16 |
| ENm008 | 230651 | chr16 |
| ENm008 | 314151 | chr16 |
| ENm008 | 325351 | chr16 |
| ENm008 | 340651 | chr16 |
| ENm008 | 446851 | chr16 |
| ENm009 | 4860146 | chr11 |
| ENm009 | 5110446 | chr11 |
| ENm009 | 5129746 | chr11 |
| ENm009 | 5174846 | chr11 |
| ENm009 | 5203746 | chr11 |
| ENm009 | 5212446 | chr11 |
| ENm009 | 5256646 | chr11 |
| ENm009 | 5263046 | chr11 |
| ENm009 | 5264746 | chr11 |
| ENm009 | 5266346 | chr11 |
| ENm009 | 5275846 | chr11 |
| ENm009 | 5313146 | chr11 |
| ENm009 | 5341446 | chr11 |
| ENm009 | 5467546 | chr11 |
| ENm009 | 5486946 | chr11 |
| ENm009 | 5508746 | chr11 |
| ENm009 | 5534946 | chr11 |
| ENm009 | 5558646 | chr11 |
| ENm009 | 5569846 | chr11 |
| ENm009 | 5575946 | chr11 |
| ENm009 | 5599646 | chr11 |
| ENm009 | 5643846 | chr11 |
| ENm009 | 5668546 | chr11 |
| ENm010 | 26838411 | chr7 |
| ENm010 | 27176511 | chr7 |
| ENm010 | 27185711 | chr7 |
| ENm011 | 1822642 | chr11 |
| ENm011 | 1956842 | chr11 |
| ENm011 | 1966142 | chr11 |
| ENm011 | 2264742 | chr11 |
| ENm011 | 2280842 | chr11 |
| ENm013 | 89513290 | chr7 |
| ENm013 | 89852890 | chr7 |
| ENm014 | 125936257 | chr7 |
| ENm014 | 126111957 | chr7 |
| ENm014 | 126598157 | chr7 |
| ENm014 | 126599857 | chr7 |
| ENm014 | 126607157 | chr7 |
| ENm014 | 126615557 | chr7 |
| ENr111 | 29585966 | chr13 |
| ENr111 | 29701266 | chr13 |
| ENr111 | 29744866 | chr13 |
| ENr111 | 29794366 | chr13 |
| ENr111 | 29812566 | chr13 |
| ENr111 | 29835566 | chr13 |
| ENr111 | 29867866 | chr13 |
| ENr111 | 29880966 | chr13 |
| ENr112 | 51800906 | chr2 |
| ENr121 | 118426154 | chr2 |
| ENr123 | 38779927 | chr12 |
| ENr131 | 234380275 | chr2 |
| ENr131 | 234389975 | chr2 |
| ENr131 | 234483175 | chr2 |
| ENr131 | 234531075 | chr2 |
| ENr132 | 112394915 | chr13 |
| ENr132 | 112405415 | chr13 |
| ENr132 | 112415515 | chr13 |
| ENr132 | 112431115 | chr13 |
| ENr132 | 112440115 | chr13 |
| ENr132 | 112443815 | chr13 |
| ENr132 | 112465015 | chr13 |
| ENr133 | 39251917 | chr21 |
| ENr133 | 39279717 | chr21 |
| ENr133 | 39298017 | chr21 |
| ENr133 | 39388817 | chr21 |
| ENr133 | 39399617 | chr21 |
| ENr133 | 39408117 | chr21 |
| ENr133 | 39502617 | chr21 |
| ENr133 | 39612417 | chr21 |
| ENr133 | 39625217 | chr21 |
| ENr133 | 39657917 | chr21 |
| ENr133 | 39716217 | chr21 |
| ENr133 | 39724417 | chr21 |
| ENr212 | 141891601 | chr5 |
| ENr212 | 141904901 | chr5 |
| ENr212 | 141958201 | chr5 |
| ENr212 | 142186101 | chr5 |
| ENr212 | 142197301 | chr5 |
| ENr212 | 142206301 | chr5 |
| ENr212 | 142212101 | chr5 |
| ENr221 | 55918057 | chr5 |
| ENr221 | 56019957 | chr5 |
| ENr221 | 56095257 | chr5 |
| ENr221 | 56158057 | chr5 |
| ENr221 | 56181157 | chr5 |
| ENr222 | 132703490 | chr6 |
| ENr223 | 74030903 | chr6 |
| ENr223 | 74051903 | chr6 |
| ENr223 | 74177803 | chr6 |
| ENr223 | 74188403 | chr6 |
| ENr223 | 74278003 | chr6 |
| ENr231 | 148097384 | chr1 |
| ENr231 | 148156184 | chr1 |
| ENr231 | 148158284 | chr1 |
| ENr231 | 148360784 | chr1 |
| ENr231 | 148370184 | chr1 |
| ENr231 | 148381984 | chr1 |
| ENr231 | 148405484 | chr1 |
| ENr231 | 148453184 | chr1 |
| ENr232 | 128784506 | chr9 |
| ENr232 | 128864506 | chr9 |
| ENr232 | 128870906 | chr9 |
| ENr232 | 128911506 | chr9 |
| ENr232 | 128983406 | chr9 |
| ENr232 | 129009406 | chr9 |
| ENr232 | 129026106 | chr9 |
| ENr232 | 129079306 | chr9 |
| ENr232 | 129088406 | chr9 |
| ENr232 | 129176506 | chr9 |
| ENr232 | 129243106 | chr9 |
| ENr232 | 129249206 | chr9 |
| ENr232 | 129255506 | chr9 |
| ENr232 | 129257306 | chr9 |
| ENr233 | 41595439 | chr15 |
| ENr233 | 41647839 | chr15 |
| ENr233 | 41736739 | chr15 |
| ENr233 | 41747339 | chr15 |
| ENr233 | 41893039 | chr15 |
| ENr233 | 41980039 | chr15 |
| ENr323 | 108394047 | chr6 |
| ENr323 | 108409747 | chr6 |
| ENr323 | 108411547 | chr6 |
| ENr323 | 108418847 | chr6 |
| ENr323 | 108430447 | chr6 |
| ENr323 | 108650947 | chr6 |
| ENr323 | 108657247 | chr6 |
| ENr323 | 108663547 | chr6 |
| ENr323 | 108680147 | chr6 |
| ENr323 | 108705447 | chr6 |
| ENr323 | 108789147 | chr6 |
| ENr324 | 122585300 | chrX |
| ENr324 | 122660300 | chrX |
| ENr324 | 122677100 | chrX |
| ENr324 | 122684500 | chrX |
| ENr324 | 122729100 | chrX |
| ENr324 | 122764700 | chrX |
| ENr324 | 122828800 | chrX |
| ENr324 | 122844300 | chrX |
| ENr324 | 122852400 | chrX |
| ENr324 | 122881500 | chrX |
| ENr324 | 122932200 | chrX |
| ENr331 | 220143501 | chr2 |
| ENr331 | 220151101 | chr2 |
| ENr331 | 220160401 | chr2 |
| ENr331 | 220166101 | chr2 |
| ENr331 | 220200401 | chr2 |
| ENr331 | 220202701 | chr2 |
| ENr331 | 220209201 | chr2 |
| ENr331 | 220216101 | chr2 |
| ENr331 | 220218001 | chr2 |
| ENr331 | 220267101 | chr2 |
| ENr331 | 220335501 | chr2 |
| ENr331 | 220354001 | chr2 |
| ENr331 | 220376001 | chr2 |
| ENr331 | 220414101 | chr2 |
| ENr332 | 64024839 | chr11 |
| ENr332 | 64079839 | chr11 |
| ENr332 | 64095939 | chr11 |
| ENr332 | 64182639 | chr11 |
| ENr332 | 64190039 | chr11 |
| ENr332 | 64235339 | chr11 |
| ENr332 | 64278439 | chr11 |
| ENr332 | 64284839 | chr11 |
| ENr332 | 64379739 | chr11 |
| ENr332 | 64394939 | chr11 |
| ENr332 | 64413039 | chr11 |
| ENr333 | 33322679 | chr20 |
| ENr333 | 33357279 | chr20 |
| ENr333 | 33363379 | chr20 |
| ENr333 | 33370279 | chr20 |
| ENr333 | 33379379 | chr20 |
| ENr333 | 33389679 | chr20 |
| ENr333 | 33395479 | chr20 |
| ENr333 | 33415279 | chr20 |
| ENr333 | 33490479 | chr20 |
| ENr333 | 33513679 | chr20 |
| ENr333 | 33565879 | chr20 |
| ENr333 | 33659279 | chr20 |
| ENr333 | 33692979 | chr20 |
| ENr333 | 33709579 | chr20 |
| ENr334 | 41614445 | chr6 |
| ENr334 | 41654345 | chr6 |
| ENr334 | 41823645 | chr6 |
| ENr334 | 41843945 | chr6 |
| ENr334 | 41894545 | chr6 |

TABLE 5

| | | |
|---|---|---|
| ENm001 | 115465422 | chr7 |
| ENm001 | 115486622 | chr7 |
| ENm001 | 115756822 | chr7 |
| ENm001 | 115827322 | chr7 |
| ENm001 | 115849622 | chr7 |
| ENm001 | 115969722 | chr7 |
| ENm001 | 115971722 | chr7 |
| ENm001 | 116017122 | chr7 |
| ENm001 | 116036722 | chr7 |
| ENm001 | 116090422 | chr7 |
| ENm001 | 116138922 | chr7 |
| ENm001 | 116254822 | chr7 |
| ENm001 | 116352122 | chr7 |
| ENm001 | 116360022 | chr7 |
| ENm001 | 116374022 | chr7 |
| ENm001 | 116376022 | chr7 |
| ENm001 | 116383422 | chr7 |
| ENm001 | 116545622 | chr7 |
| ENm001 | 116720322 | chr7 |
| ENm001 | 116864922 | chr7 |
| ENm001 | 116886522 | chr7 |
| ENm001 | 116907622 | chr7 |
| ENm001 | 116910422 | chr7 |
| ENm001 | 117043022 | chr7 |
| ENm001 | 117069722 | chr7 |
| ENm001 | 117100822 | chr7 |
| ENm001 | 117122622 | chr7 |
| ENm001 | 117197322 | chr7 |
| ENm002 | 131338564 | chr5 |
| ENm002 | 131365964 | chr5 |
| ENm002 | 131642664 | chr5 |
| ENm002 | 131686664 | chr5 |
| ENm002 | 131751064 | chr5 |
| ENm002 | 131801464 | chr5 |
| ENm002 | 131809164 | chr5 |
| ENm002 | 131814764 | chr5 |
| ENm002 | 131820564 | chr5 |
| ENm002 | 131838364 | chr5 |
| ENm002 | 132118864 | chr5 |
| ENm002 | 132171364 | chr5 |
| ENm003 | 116063866 | chr11 |
| ENm003 | 116072166 | chr11 |
| ENm003 | 116079466 | chr11 |
| ENm003 | 116085266 | chr11 |
| ENm003 | 116091566 | chr11 |
| ENm003 | 116107566 | chr11 |
| ENm003 | 116307166 | chr11 |
| ENm003 | 116332866 | chr11 |
| ENm003 | 116345366 | chr11 |
| ENm003 | 116370366 | chr11 |
| ENm003 | 116412966 | chr11 |
| ENm003 | 116449066 | chr11 |
| ENm003 | 116453766 | chr11 |
| ENm004 | 30345858 | chr22 |
| ENm004 | 30368358 | chr22 |
| ENm004 | 30588058 | chr22 |
| ENm004 | 30673858 | chr22 |
| ENm004 | 30681258 | chr22 |
| ENm004 | 31046458 | chr22 |
| ENm004 | 31057458 | chr22 |
| ENm004 | 31289358 | chr22 |
| ENm004 | 31343558 | chr22 |
| ENm004 | 31485458 | chr22 |
| ENm004 | 31524758 | chr22 |
| ENm004 | 31535158 | chr22 |
| ENm004 | 31551258 | chr22 |
| ENm004 | 31707758 | chr22 |
| ENm004 | 31715158 | chr22 |
| ENm004 | 31740958 | chr22 |
| ENm004 | 31783758 | chr22 |
| ENm004 | 31814458 | chr22 |
| ENm005 | 32721987 | chr21 |
| ENm005 | 32772287 | chr21 |
| ENm005 | 32775787 | chr21 |
| ENm005 | 32788087 | chr21 |
| ENm005 | 32806087 | chr21 |
| ENm005 | 32817887 | chr21 |
| ENm005 | 32850087 | chr21 |
| ENm005 | 32899187 | chr21 |
| ENm005 | 33100787 | chr21 |
| ENm005 | 33247187 | chr21 |
| ENm005 | 33253887 | chr21 |
| ENm005 | 33259187 | chr21 |
| ENm005 | 33329687 | chr21 |
| ENm005 | 33405587 | chr21 |
| ENm005 | 33407387 | chr21 |
| ENm005 | 33410487 | chr21 |
| ENm005 | 33421487 | chr21 |
| ENm005 | 33439187 | chr21 |
| ENm005 | 33456887 | chr21 |
| ENm005 | 33707287 | chr21 |
| ENm005 | 33950887 | chr21 |
| ENm005 | 33962487 | chr21 |
| ENm005 | 33969187 | chr21 |
| ENm005 | 33978087 | chr21 |
| ENm005 | 33981287 | chr21 |
| ENm005 | 33990987 | chr21 |
| ENm005 | 34088287 | chr21 |
| ENm005 | 34153287 | chr21 |
| ENm005 | 34241787 | chr21 |
| ENm005 | 34269687 | chr21 |
| ENm005 | 34316687 | chr21 |
| ENm006 | 152649295 | chrX |
| ENm006 | 152664895 | chrX |
| ENm006 | 152727395 | chrX |
| ENm006 | 152820295 | chrX |
| ENm006 | 152821995 | chrX |
| ENm006 | 152827895 | chrX |
| ENm006 | 152837595 | chrX |
| ENm006 | 152878095 | chrX |
| ENm006 | 152960295 | chrX |
| ENm006 | 152983495 | chrX |
| ENm006 | 152997795 | chrX |
| ENm006 | 153020895 | chrX |
| ENm006 | 153035595 | chrX |
| ENm006 | 153684195 | chrX |
| ENm006 | 153839395 | chrX |
| ENm007 | 59037535 | chr19 |
| ENm007 | 59236635 | chr19 |
| ENm007 | 59470835 | chr19 |
| ENm007 | 59492935 | chr19 |
| ENm007 | 59528635 | chr19 |
| ENm007 | 59594535 | chr19 |
| ENm007 | 59639335 | chr19 |
| ENm007 | 59676535 | chr19 |
| ENm008 | 321251 | chr16 |
| ENm008 | 447651 | chr16 |
| ENm008 | 473551 | chr16 |
| ENm008 | 481451 | chr16 |
| ENm009 | 4840846 | chr11 |
| ENm009 | 5115546 | chr11 |
| ENm009 | 5430246 | chr11 |
| ENm009 | 5597546 | chr11 |
| ENm009 | 5668446 | chr11 |
| ENm010 | 26758211 | chr7 |
| ENm010 | 26843211 | chr7 |
| ENm010 | 26914311 | chr7 |
| ENm010 | 27157311 | chr7 |
| ENm010 | 27187811 | chr7 |
| ENm011 | 1750942 | chr11 |
| ENm011 | 1886442 | chr11 |
| ENm011 | 1982642 | chr11 |
| ENm012 | 113648834 | chr7 |
| ENm012 | 113864434 | chr7 |
| ENm012 | 113893234 | chr7 |
| ENm012 | 113923534 | chr7 |
| ENm012 | 113943634 | chr7 |
| ENm012 | 114056534 | chr7 |
| ENm012 | 114058634 | chr7 |
| ENm012 | 114077434 | chr7 |
| ENm012 | 114164634 | chr7 |
| ENm012 | 114179334 | chr7 |
| ENm012 | 114206534 | chr7 |
| ENm012 | 114220634 | chr7 |
| ENm012 | 114236934 | chr7 |
| ENm012 | 114242634 | chr7 |
| ENm012 | 114266434 | chr7 |
| ENm013 | 89498590 | chr7 |
| ENm013 | 89896790 | chr7 |
| ENm013 | 89935690 | chr7 |
| ENm013 | 89951690 | chr7 |
| ENm013 | 89983790 | chr7 |
| ENm013 | 89985590 | chr7 |
| ENm013 | 90000390 | chr7 |
| ENm013 | 90038590 | chr7 |
| ENm013 | 90166590 | chr7 |
| ENm013 | 90306590 | chr7 |
| ENm013 | 90317890 | chr7 |
| ENm013 | 90408590 | chr7 |
| ENm013 | 90487190 | chr7 |
| ENm014 | 125759157 | chr7 |
| ENm014 | 125935457 | chr7 |
| ENm014 | 126067457 | chr7 |
| ENm014 | 126116557 | chr7 |
| ENm014 | 126330357 | chr7 |
| ENm014 | 126348857 | chr7 |
| ENm014 | 126423557 | chr7 |
| ENm014 | 126449257 | chr7 |
| ENm014 | 126769957 | chr7 |
| ENr111 | 29430566 | chr13 |
| ENr111 | 29436966 | chr13 |
| ENr111 | 29492066 | chr13 |
| ENr111 | 29510466 | chr13 |
| ENr111 | 29524966 | chr13 |
| ENr111 | 29550666 | chr13 |
| ENr111 | 29586066 | chr13 |
| ENr111 | 29849366 | chr13 |
| ENr111 | 29867866 | chr13 |
| ENr111 | 29880966 | chr13 |
| ENr112 | 51736606 | chr2 |
| ENr112 | 51772306 | chr2 |
| ENr112 | 51800706 | chr2 |
| ENr113 | 118877609 | chr4 |
| ENr113 | 119004909 | chr4 |
| ENr114 | 55260469 | chr10 |
| ENr121 | 118026154 | chr2 |
| ENr121 | 118325054 | chr2 |
| ENr121 | 118494854 | chr2 |
| ENr122 | 59502551 | chr18 |
| ENr122 | 59836351 | chr18 |
| ENr122 | 59902051 | chr18 |
| ENr123 | 38701527 | chr12 |
| ENr123 | 38712827 | chr12 |
| ENr123 | 38835427 | chr12 |
| ENr131 | 234390475 | chr2 |
| ENr131 | 234608475 | chr2 |
| ENr131 | 234620175 | chr2 |
| ENr131 | 234665375 | chr2 |
| ENr132 | 112406515 | chr13 |
| ENr132 | 112415215 | chr13 |
| ENr132 | 112428615 | chr13 |
| ENr132 | 112437715 | chr13 |
| ENr132 | 112445415 | chr13 |
| ENr132 | 112483115 | chr13 |
| ENr132 | 112595115 | chr13 |
| ENr132 | 112604515 | chr13 |
| ENr132 | 112608115 | chr13 |
| ENr132 | 112725415 | chr13 |
| ENr133 | 39275117 | chr21 |
| ENr133 | 39282617 | chr21 |
| ENr133 | 39284817 | chr21 |
| ENr133 | 39316317 | chr21 |
| ENr133 | 39323317 | chr21 |
| ENr133 | 39376217 | chr21 |
| ENr133 | 39431717 | chr21 |
| ENr133 | 39724017 | chr21 |
| ENr211 | 25804378 | chr16 |
| ENr211 | 25806278 | chr16 |
| ENr211 | 25844478 | chr16 |
| ENr211 | 25870178 | chr16 |
| ENr211 | 25938978 | chr16 |
| ENr211 | 25969078 | chr16 |
| ENr211 | 25974778 | chr16 |
| ENr211 | 25990278 | chr16 |
| ENr211 | 26052278 | chr16 |
| ENr211 | 26096178 | chr16 |
| ENr211 | 26125178 | chr16 |
| ENr211 | 26138678 | chr16 |
| ENr211 | 26200778 | chr16 |
| ENr212 | 141900901 | chr5 |
| ENr212 | 141910401 | chr5 |
| ENr212 | 142034401 | chr5 |
| ENr212 | 142044501 | chr5 |
| ENr212 | 142077001 | chr5 |
| ENr212 | 142142901 | chr5 |
| ENr212 | 142157301 | chr5 |
| ENr212 | 142177301 | chr5 |
| ENr212 | 142186401 | chr5 |
| ENr212 | 142206301 | chr5 |
| ENr212 | 142208401 | chr5 |
| ENr212 | 142217101 | chr5 |
| ENr212 | 142223201 | chr5 |
| ENr212 | 142225001 | chr5 |
| ENr212 | 142232701 | chr5 |
| ENr212 | 142258701 | chr5 |
| ENr212 | 142342401 | chr5 |
| ENr213 | 23735682 | chr18 |
| ENr213 | 23819382 | chr18 |
| ENr213 | 23879982 | chr18 |
| ENr213 | 23882882 | chr18 |
| ENr213 | 23898482 | chr18 |
| ENr213 | 23908582 | chr18 |
| ENr213 | 23920882 | chr18 |
| ENr213 | 23944582 | chr18 |
| ENr213 | 23989082 | chr18 |
| ENr213 | 23994282 | chr18 |
| ENr221 | 55939657 | chr5 |
| ENr221 | 55947157 | chr5 |
| ENr221 | 55969057 | chr5 |
| ENr221 | 56001557 | chr5 |
| ENr221 | 56030657 | chr5 |
| ENr221 | 56046557 | chr5 |
| ENr221 | 56048657 | chr5 |
| ENr221 | 56066357 | chr5 |
| ENr221 | 56158357 | chr5 |
| ENr221 | 56162657 | chr5 |
| ENr222 | 132256790 | chr6 |
| ENr222 | 132263090 | chr6 |
| ENr222 | 132271090 | chr6 |
| ENr222 | 132300390 | chr6 |
| ENr222 | 132318190 | chr6 |
| ENr222 | 132451590 | chr6 |
| ENr222 | 132495290 | chr6 |
| ENr222 | 132599490 | chr6 |
| ENr222 | 132620790 | chr6 |
| ENr223 | 73843903 | chr6 |
| ENr223 | 73851703 | chr6 |
| ENr223 | 73965203 | chr6 |
| ENr231 | 148080384 | chr1 |
| ENr231 | 148157384 | chr1 |
| ENr231 | 148299384 | chr1 |
| ENr231 | 148334284 | chr1 |
| ENr231 | 148405784 | chr1 |
| ENr232 | 128913406 | chr9 |
| ENr232 | 128968806 | chr9 |
| ENr232 | 128982306 | chr9 |
| ENr232 | 128983906 | chr9 |
| ENr232 | 128986606 | chr9 |
| ENr232 | 129009106 | chr9 |
| ENr232 | 129064206 | chr9 |
| ENr232 | 129119806 | chr9 |
| ENr232 | 129177406 | chr9 |
| ENr232 | 129244406 | chr9 |
| ENr232 | 129246606 | chr9 |
| ENr233 | 41596239 | chr15 |
| ENr233 | 41610339 | chr15 |
| ENr233 | 42000139 | chr15 |
| ENr233 | 42007639 | chr15 |
| ENr233 | 42009339 | chr15 |
| ENr311 | 53103726 | chr14 |
| ENr311 | 53108426 | chr14 |
| ENr311 | 53135826 | chr14 |
| ENr311 | 53278626 | chr14 |
| ENr311 | 53280626 | chr14 |
| ENr311 | 53387326 | chr14 |
| ENr312 | 130650448 | chr11 |
| ENr312 | 130665848 | chr11 |
| ENr312 | 130698548 | chr11 |
| ENr312 | 130747548 | chr11 |
| ENr312 | 130783948 | chr11 |
| ENr312 | 130840248 | chr11 |
| ENr312 | 130846348 | chr11 |
| ENr312 | 130873948 | chr11 |
| ENr312 | 130932848 | chr11 |
| ENr312 | 130966248 | chr11 |
| ENr312 | 130992848 | chr11 |
| ENr312 | 131015248 | chr11 |
| ENr312 | 131017148 | chr11 |
| ENr312 | 131029448 | chr11 |
| ENr312 | 131037248 | chr11 |
| ENr313 | 60845900 | chr16 |
| ENr313 | 60864100 | chr16 |
| ENr313 | 60964200 | chr16 |
| ENr313 | 61020700 | chr16 |
| ENr313 | 61257100 | chr16 |
| ENr321 | 118979071 | chr8 |
| ENr321 | 118987271 | chr8 |
| ENr321 | 119002671 | chr8 |
| ENr321 | 119015971 | chr8 |
| ENr321 | 119023171 | chr8 |
| ENr321 | 119028971 | chr8 |
| ENr321 | 119040471 | chr8 |
| ENr321 | 119070471 | chr8 |
| ENr321 | 119076671 | chr8 |
| ENr321 | 119092671 | chr8 |
| ENr321 | 119099771 | chr8 |
| ENr321 | 119118771 | chr8 |
| ENr321 | 119129171 | chr8 |
| ENr321 | 119134271 | chr8 |
| ENr321 | 119143271 | chr8 |
| ENr321 | 119151671 | chr8 |
| ENr321 | 119154071 | chr8 |
| ENr321 | 119156171 | chr8 |
| ENr321 | 119157771 | chr8 |
| ENr321 | 119160271 | chr8 |
| ENr321 | 119162171 | chr8 |
| ENr321 | 119169671 | chr8 |
| ENr321 | 119204571 | chr8 |
| ENr321 | 119291571 | chr8 |
| ENr321 | 119338571 | chr8 |
| ENr322 | 98529874 | chr14 |
| ENr322 | 98637574 | chr14 |
| ENr322 | 98669374 | chr14 |
| ENr322 | 98724774 | chr14 |
| ENr322 | 98778174 | chr14 |
| ENr322 | 98794674 | chr14 |
| ENr322 | 98800574 | chr14 |
| ENr322 | 98814074 | chr14 |
| ENr322 | 98920074 | chr14 |
| ENr322 | 98931174 | chr14 |
| ENr322 | 98949574 | chr14 |
| ENr323 | 108415547 | chr6 |
| ENr323 | 108418547 | chr6 |
| ENr323 | 108500347 | chr6 |
| ENr324 | 122685000 | chrX |
| ENr324 | 122783000 | chrX |
| ENr324 | 122838100 | chrX |
| ENr331 | 220151101 | chr2 |
| ENr331 | 220176701 | chr2 |
| ENr331 | 220197501 | chr2 |
| ENr331 | 220203801 | chr2 |
| ENr331 | 220211301 | chr2 |
| ENr331 | 220251701 | chr2 |
| ENr331 | 220267801 | chr2 |
| ENr331 | 220361801 | chr2 |
| ENr331 | 220376101 | chr2 |
| ENr331 | 220389101 | chr2 |
| ENr331 | 220391601 | chr2 |
| ENr331 | 220398101 | chr2 |
| ENr331 | 220418401 | chr2 |
| ENr331 | 220562701 | chr2 |
| ENr331 | 220592201 | chr2 |
| ENr332 | 64083239 | chr11 |
| ENr332 | 64169039 | chr11 |
| ENr332 | 64235439 | chr11 |
| ENr332 | 64250039 | chr11 |
| ENr332 | 64264439 | chr11 |
| ENr332 | 64285239 | chr11 |
| ENr332 | 64287939 | chr11 |
| ENr332 | 64412039 | chr11 |
| ENr333 | 33363879 | chr20 |
| ENr333 | 33488679 | chr20 |
| ENr333 | 33612179 | chr20 |
| ENr333 | 33691379 | chr20 |
| ENr333 | 33693279 | chr20 |
| ENr333 | 33696479 | chr20 |
| ENr334 | 41483345 | chr6 |
| ENr334 | 41518945 | chr6 |
| ENr334 | 41531945 | chr6 |
| ENr334 | 41538545 | chr6 |
| ENr334 | 41547645 | chr6 |
| ENr334 | 41564145 | chr6 |
| ENr334 | 41566045 | chr6 |
| ENr334 | 41570545 | chr6 |
| ENr334 | 41630545 | chr6 |
| ENr334 | 41638445 | chr6 |
| ENr334 | 41646145 | chr6 |
| ENr334 | 41647945 | chr6 |
| ENr334 | 41654745 | chr6 |
| ENr334 | 41660945 | chr6 |
| ENr334 | 41676445 | chr6 |
| ENr334 | 41720245 | chr6 |
| ENr334 | 41756545 | chr6 |
| ENr334 | 41804845 | chr6 |

TABLE 6

| | | |
|---|---|---|
| ENm001 | 115465022 | chr7 |
| ENm001 | 115505922 | chr7 |
| ENm001 | 115589622 | chr7 |
| ENm001 | 116016022 | chr7 |
| ENm001 | 116036322 | chr7 |
| ENm001 | 116104822 | chr7 |
| ENm001 | 116111122 | chr7 |
| ENm001 | 116392722 | chr7 |
| ENm001 | 116407622 | chr7 |
| ENm001 | 116485222 | chr7 |
| ENm001 | 116900622 | chr7 |
| ENm001 | 117062422 | chr7 |
| ENm001 | 117069922 | chr7 |
| ENm001 | 117101322 | chr7 |
| ENm001 | 117161922 | chr7 |
| ENm001 | 117216222 | chr7 |
| ENm001 | 117238322 | chr7 |
| ENm002 | 131347464 | chr5 |
| ENm002 | 131359064 | chr5 |
| ENm002 | 131360664 | chr5 |
| ENm002 | 131366464 | chr5 |
| ENm002 | 131569764 | chr5 |
| ENm002 | 131589964 | chr5 |
| ENm002 | 131598564 | chr5 |
| ENm002 | 131622564 | chr5 |
| ENm002 | 131629164 | chr5 |
| ENm002 | 131659264 | chr5 |
| ENm002 | 131665464 | chr5 |
| ENm002 | 131685464 | chr5 |
| ENm002 | 131752164 | chr5 |
| ENm002 | 131760164 | chr5 |
| ENm002 | 131791864 | chr5 |
| ENm002 | 131801264 | chr5 |
| ENm002 | 131809064 | chr5 |
| ENm002 | 131828764 | chr5 |
| ENm002 | 131839264 | chr5 |
| ENm002 | 131841264 | chr5 |
| ENm002 | 132123764 | chr5 |
| ENm002 | 132135264 | chr5 |
| ENm002 | 132152164 | chr5 |
| ENm002 | 132164164 | chr5 |
| ENm002 | 132171664 | chr5 |
| ENm002 | 132203864 | chr5 |
| ENm003 | 115977666 | chr11 |
| ENm003 | 116064166 | chr11 |
| ENm003 | 116072166 | chr11 |
| ENm003 | 116079166 | chr11 |
| ENm003 | 116203566 | chr11 |
| ENm003 | 116213566 | chr11 |
| ENm003 | 116228666 | chr11 |
| ENm003 | 116234366 | chr11 |
| ENm003 | 116250366 | chr11 |
| ENm003 | 116447766 | chr11 |
| ENm003 | 116449466 | chr11 |
| ENm004 | 30305158 | chr22 |
| ENm004 | 30322758 | chr22 |
| ENm004 | 30345358 | chr22 |
| ENm004 | 30771558 | chr22 |
| ENm004 | 30779758 | chr22 |
| ENm004 | 31252458 | chr22 |
| ENm004 | 31254158 | chr22 |
| ENm004 | 31260758 | chr22 |
| ENm004 | 31267158 | chr22 |
| ENm004 | 31276258 | chr22 |
| ENm004 | 31277858 | chr22 |
| ENm004 | 31325858 | chr22 |
| ENm004 | 31327458 | chr22 |
| ENm004 | 31337458 | chr22 |
| ENm004 | 31343758 | chr22 |
| ENm004 | 31352858 | chr22 |
| ENm004 | 31364958 | chr22 |
| ENm004 | 31370758 | chr22 |
| ENm004 | 31404658 | chr22 |
| ENm004 | 31419158 | chr22 |
| ENm004 | 31433258 | chr22 |
| ENm004 | 31434958 | chr22 |
| ENm004 | 31456058 | chr22 |
| ENm004 | 31466158 | chr22 |
| ENm004 | 31474258 | chr22 |
| ENm004 | 31485458 | chr22 |
| ENm004 | 31506258 | chr22 |
| ENm004 | 31538958 | chr22 |
| ENm004 | 31551658 | chr22 |
| ENm004 | 31560458 | chr22 |
| ENm004 | 31601758 | chr22 |
| ENm004 | 31671858 | chr22 |
| ENm004 | 31698558 | chr22 |
| ENm004 | 31707158 | chr22 |
| ENm004 | 31714858 | chr22 |
| ENm004 | 31750258 | chr22 |
| ENm005 | 32721587 | chr21 |
| ENm005 | 32745887 | chr21 |
| ENm005 | 32786987 | chr21 |
| ENm005 | 32793487 | chr21 |
| ENm005 | 32991787 | chr21 |
| ENm005 | 33212187 | chr21 |
| ENm005 | 33675787 | chr21 |
| ENm005 | 33707887 | chr21 |
| ENm005 | 33950587 | chr21 |
| ENm005 | 33962587 | chr21 |
| ENm005 | 33978887 | chr21 |
| ENm005 | 33991787 | chr21 |
| ENm005 | 34065987 | chr21 |
| ENm005 | 34109887 | chr21 |
| ENm005 | 34118187 | chr21 |
| ENm005 | 34139087 | chr21 |
| ENm005 | 34188287 | chr21 |
| ENm005 | 34242387 | chr21 |
| ENm005 | 34262487 | chr21 |
| ENm005 | 34268987 | chr21 |
| ENm005 | 34317687 | chr21 |
| ENm006 | 152665495 | chrX |
| ENm006 | 152689295 | chrX |
| ENm006 | 152727295 | chrX |
| ENm006 | 152785995 | chrX |
| ENm006 | 152806095 | chrX |
| ENm006 | 152808395 | chrX |
| ENm006 | 152826695 | chrX |
| ENm006 | 152837795 | chrX |
| ENm006 | 152850495 | chrX |
| ENm006 | 152869995 | chrX |
| ENm006 | 153298095 | chrX |
| ENm006 | 153324795 | chrX |
| ENm006 | 153332595 | chrX |
| ENm006 | 153527095 | chrX |
| ENm006 | 153529195 | chrX |
| ENm006 | 153577295 | chrX |
| ENm006 | 153591595 | chrX |
| ENm007 | 59186135 | chr19 |
| ENm007 | 59291535 | chr19 |
| ENm007 | 59369135 | chr19 |
| ENm007 | 59404535 | chr19 |
| ENm008 | 67251 | chr16 |
| ENm008 | 103351 | chr16 |
| ENm008 | 321551 | chr16 |
| ENm008 | 336051 | chr16 |
| ENm008 | 447451 | chr16 |
| ENm008 | 473751 | chr16 |
| ENm008 | 481951 | chr16 |
| ENm009 | 5668546 | chr11 |
| ENm009 | 5702146 | chr11 |
| ENm010 | 27024511 | chr7 |
| ENm010 | 27026711 | chr7 |
| ENm010 | 27039511 | chr7 |
| ENm010 | 27063811 | chr7 |
| ENm010 | 27070411 | chr7 |
| ENm010 | 27119011 | chr7 |
| ENm010 | 27159911 | chr7 |
| ENm010 | 27186411 | chr7 |
| ENm010 | 27188211 | chr7 |
| ENm011 | 1798342 | chr11 |
| ENm011 | 1810642 | chr11 |
| ENm011 | 1822942 | chr11 |
| ENm011 | 1841742 | chr11 |
| ENm011 | 1854442 | chr11 |
| ENm011 | 1886142 | chr11 |
| ENm011 | 1933842 | chr11 |
| ENm011 | 1942542 | chr11 |
| ENm011 | 1948042 | chr11 |
| ENm011 | 1959342 | chr11 |
| ENm011 | 1967242 | chr11 |
| ENm011 | 1972042 | chr11 |
| ENm011 | 2013042 | chr11 |
| ENm011 | 2099142 | chr11 |
| ENm011 | 2281842 | chr11 |
| ENm012 | 113649134 | chr7 |
| ENm012 | 113893434 | chr7 |
| ENm012 | 114070334 | chr7 |
| ENm012 | 114076734 | chr7 |
| ENm012 | 114163434 | chr7 |
| ENm012 | 114221234 | chr7 |
| ENm012 | 114237434 | chr7 |
| ENm012 | 114321934 | chr7 |
| ENm012 | 114459134 | chr7 |
| ENm012 | 114465334 | chr7 |
| ENm013 | 89847590 | chr7 |
| ENm013 | 89853590 | chr7 |
| ENm013 | 89897690 | chr7 |
| ENm013 | 89935390 | chr7 |
| ENm013 | 89952090 | chr7 |
| ENm013 | 89981590 | chr7 |
| ENm013 | 90001090 | chr7 |
| ENm013 | 90090990 | chr7 |
| ENm014 | 125923057 | chr7 |
| ENm014 | 125936157 | chr7 |
| ENm014 | 126038857 | chr7 |
| ENm014 | 126423357 | chr7 |
| ENm014 | 126443057 | chr7 |
| ENr111 | 29477666 | chr13 |
| ENr111 | 29494766 | chr13 |
| ENr111 | 29505966 | chr13 |
| ENr111 | 29585466 | chr13 |
| ENr111 | 29593366 | chr13 |
| ENr111 | 29599166 | chr13 |
| ENr111 | 29606566 | chr13 |
| ENr111 | 29615166 | chr13 |
| ENr111 | 29630266 | chr13 |
| ENr111 | 29644766 | chr13 |
| ENr111 | 29659566 | chr13 |
| ENr111 | 29667166 | chr13 |
| ENr111 | 29812966 | chr13 |
| ENr111 | 29836766 | chr13 |
| ENr111 | 29861666 | chr13 |
| ENr111 | 29881566 | chr13 |
| ENr111 | 29903166 | chr13 |
| ENr113 | 118700409 | chr4 |
| ENr121 | 118186854 | chr2 |
| ENr121 | 118200854 | chr2 |
| ENr121 | 118244554 | chr2 |
| ENr122 | 59798651 | chr18 |
| ENr131 | 234390275 | chr2 |
| ENr131 | 234665175 | chr2 |
| ENr132 | 112354715 | chr13 |
| ENr132 | 112360615 | chr13 |
| ENr132 | 112405715 | chr13 |
| ENr132 | 112413815 | chr13 |
| ENr132 | 112415715 | chr13 |
| ENr132 | 112422515 | chr13 |
| ENr132 | 112431815 | chr13 |
| ENr132 | 112459315 | chr13 |
| ENr132 | 112483715 | chr13 |
| ENr132 | 112505815 | chr13 |
| ENr132 | 112596515 | chr13 |
| ENr132 | 112724915 | chr13 |
| ENr133 | 39252417 | chr21 |
| ENr133 | 39282217 | chr21 |
| ENr133 | 39288517 | chr21 |
| ENr133 | 39299117 | chr21 |
| ENr133 | 39315217 | chr21 |
| ENr133 | 39323317 | chr21 |
| ENr133 | 39390217 | chr21 |
| ENr133 | 39391917 | chr21 |
| ENr133 | 39431917 | chr21 |
| ENr133 | 39454717 | chr21 |
| ENr133 | 39724517 | chr21 |
| ENr211 | 25834378 | chr16 |
| ENr211 | 26108478 | chr16 |
| ENr211 | 26200778 | chr16 |
| ENr212 | 141891101 | chr5 |
| ENr212 | 141903201 | chr5 |
| ENr212 | 141910501 | chr5 |
| ENr212 | 141920901 | chr5 |
| ENr212 | 141927101 | chr5 |
| ENr212 | 141950001 | chr5 |
| ENr212 | 141959201 | chr5 |
| ENr212 | 141966601 | chr5 |
| ENr212 | 141981501 | chr5 |
| ENr212 | 141986301 | chr5 |
| ENr212 | 141996801 | chr5 |
| ENr212 | 142004701 | chr5 |
| ENr212 | 142014301 | chr5 |
| ENr212 | 142045501 | chr5 |
| ENr212 | 142057801 | chr5 |
| ENr212 | 142094501 | chr5 |
| ENr212 | 142144501 | chr5 |
| ENr212 | 142205501 | chr5 |
| ENr212 | 142224101 | chr5 |
| ENr212 | 142243301 | chr5 |
| ENr212 | 142261201 | chr5 |
| ENr212 | 142330801 | chr5 |
| ENr212 | 142342001 | chr5 |
| ENr213 | 23755982 | chr18 |
| ENr213 | 23898682 | chr18 |
| ENr213 | 23905582 | chr18 |
| ENr213 | 23912982 | chr18 |
| ENr213 | 23943482 | chr18 |
| ENr213 | 23949882 | chr18 |
| ENr213 | 23967782 | chr18 |
| ENr213 | 23969682 | chr18 |
| ENr213 | 23987182 | chr18 |
| ENr213 | 23993782 | chr18 |
| ENr213 | 23995882 | chr18 |
| ENr221 | 55889757 | chr5 |
| ENr221 | 55918057 | chr5 |
| ENr221 | 55939157 | chr5 |
| ENr221 | 55970257 | chr5 |
| ENr221 | 56019757 | chr5 |
| ENr221 | 56066257 | chr5 |
| ENr221 | 56094557 | chr5 |
| ENr221 | 56158157 | chr5 |
| ENr221 | 56168457 | chr5 |
| ENr221 | 56183257 | chr5 |
| ENr221 | 56294457 | chr5 |
| ENr222 | 132447790 | chr6 |
| ENr222 | 132495090 | chr6 |
| ENr222 | 132695390 | chr6 |
| ENr223 | 73876903 | chr6 |
| ENr223 | 73968703 | chr6 |
| ENr231 | 148096784 | chr1 |
| ENr231 | 148157284 | chr1 |
| ENr231 | 148289184 | chr1 |
| ENr231 | 148298884 | chr1 |
| ENr231 | 148333984 | chr1 |
| ENr231 | 148367984 | chr1 |
| ENr231 | 148370384 | chr1 |
| ENr231 | 148382184 | chr1 |
| ENr231 | 148406184 | chr1 |
| ENr232 | 128968606 | chr9 |
| ENr232 | 128975206 | chr9 |
| ENr232 | 128983706 | chr9 |
| ENr232 | 128987206 | chr9 |
| ENr232 | 129007106 | chr9 |
| ENr232 | 129009406 | chr9 |
| ENr232 | 129026006 | chr9 |
| ENr232 | 129066706 | chr9 |
| ENr232 | 129072206 | chr9 |
| ENr232 | 129078906 | chr9 |
| ENr232 | 129087506 | chr9 |
| ENr232 | 129164406 | chr9 |
| ENr232 | 129177206 | chr9 |
| ENr232 | 129192606 | chr9 |
| ENr232 | 129194306 | chr9 |
| ENr232 | 129244506 | chr9 |
| ENr232 | 129255706 | chr9 |
| ENr233 | 41596339 | chr15 |
| ENr233 | 41692639 | chr15 |
| ENr233 | 41747839 | chr15 |
| ENr233 | 41959339 | chr15 |
| ENr233 | 41981139 | chr15 |
| ENr233 | 41993139 | chr15 |
| ENr233 | 42000739 | chr15 |
| ENr233 | 42010939 | chr15 |
| ENr311 | 53062426 | chr14 |
| ENr311 | 53073926 | chr14 |
| ENr311 | 53107626 | chr14 |
| ENr311 | 53116226 | chr14 |
| ENr311 | 53156126 | chr14 |
| ENr311 | 53173026 | chr14 |
| ENr311 | 53191626 | chr14 |
| ENr311 | 53416926 | chr14 |
| ENr312 | 130699748 | chr11 |
| ENr312 | 130798948 | chr11 |
| ENr312 | 130840148 | chr11 |
| ENr312 | 130846748 | chr11 |
| ENr312 | 130933348 | chr11 |
| ENr312 | 131032348 | chr11 |
| ENr312 | 131045048 | chr11 |
| ENr321 | 118918171 | chr8 |
| ENr321 | 118929271 | chr8 |
| ENr321 | 118976971 | chr8 |
| ENr321 | 118978771 | chr8 |
| ENr321 | 118993771 | chr8 |
| ENr321 | 119002371 | chr8 |
| ENr321 | 119008671 | chr8 |
| ENr321 | 119014871 | chr8 |
| ENr321 | 119022371 | chr8 |
| ENr321 | 119029371 | chr8 |
| ENr321 | 119038571 | chr8 |
| ENr321 | 119076471 | chr8 |
| ENr321 | 119086971 | chr8 |
| ENr321 | 119092871 | chr8 |
| ENr321 | 119100071 | chr8 |
| ENr321 | 119107871 | chr8 |
| ENr321 | 119116671 | chr8 |
| ENr321 | 119127671 | chr8 |
| ENr321 | 119155871 | chr8 |
| ENr321 | 119203171 | chr8 |
| ENr321 | 119224471 | chr8 |
| ENr321 | 119292071 | chr8 |
| ENr322 | 98572274 | chr14 |
| ENr322 | 98669774 | chr14 |
| ENr322 | 98714074 | chr14 |
| ENr322 | 98752374 | chr14 |
| ENr322 | 98754074 | chr14 |
| ENr322 | 98767174 | chr14 |
| ENr322 | 98769474 | chr14 |
| ENr322 | 98777974 | chr14 |
| ENr322 | 98798374 | chr14 |
| ENr322 | 98937774 | chr14 |
| ENr322 | 98949374 | chr14 |
| ENr323 | 108393947 | chr6 |
| ENr323 | 108400347 | chr6 |
| ENr323 | 108418947 | chr6 |
| ENr323 | 108518647 | chr6 |
| ENr323 | 108546847 | chr6 |
| ENr323 | 108562147 | chr6 |
| ENr323 | 108680047 | chr6 |
| ENr323 | 108681847 | chr6 |
| ENr323 | 108705847 | chr6 |
| ENr324 | 122658100 | chrX |
| ENr324 | 122674300 | chrX |
| ENr324 | 122683800 | chrX |
| ENr331 | 220143201 | chr2 |
| ENr331 | 220150901 | chr2 |
| ENr331 | 220160401 | chr2 |
| ENr331 | 220190201 | chr2 |
| ENr331 | 220202401 | chr2 |
| ENr331 | 220211301 | chr2 |
| ENr331 | 220217101 | chr2 |
| ENr331 | 220251901 | chr2 |
| ENr331 | 220267801 | chr2 |
| ENr331 | 220335501 | chr2 |
| ENr331 | 220353801 | chr2 |
| ENr331 | 220372001 | chr2 |
| ENr331 | 220393101 | chr2 |
| ENr331 | 220418601 | chr2 |
| ENr331 | 220562101 | chr2 |
| ENr332 | 63972839 | chr11 |
| ENr332 | 64090439 | chr11 |
| ENr332 | 64183739 | chr11 |
| ENr332 | 64200239 | chr11 |
| ENr332 | 64284139 | chr11 |
| ENr332 | 64367339 | chr11 |
| ENr332 | 64379239 | chr11 |
| ENr332 | 64387639 | chr11 |
| ENr332 | 64413139 | chr11 |
| ENr333 | 33313079 | chr20 |
| ENr333 | 33321179 | chr20 |
| ENr333 | 33357079 | chr20 |
| ENr333 | 33371379 | chr20 |
| ENr333 | 33378879 | chr20 |
| ENr333 | 33390279 | chr20 |
| ENr333 | 33484079 | chr20 |
| ENr333 | 33518579 | chr20 |
| ENr333 | 33612079 | chr20 |
| ENr333 | 33669579 | chr20 |
| ENr334 | 41448045 | chr6 |
| ENr334 | 41519545 | chr6 |
| ENr334 | 41541045 | chr6 |
| ENr334 | 41547745 | chr6 |
| ENr334 | 41564445 | chr6 |
| ENr334 | 41570445 | chr6 |
| ENr334 | 41580745 | chr6 |
| ENr334 | 41596345 | chr6 |
| ENr334 | 41645545 | chr6 |
| ENr334 | 41648045 | chr6 |
| ENr334 | 41654445 | chr6 |
| ENr334 | 41656345 | chr6 |
| ENr334 | 41700145 | chr6 |
| ENr334 | 41721045 | chr6 |
| ENr334 | 41732345 | chr6 |
| ENr334 | 41756845 | chr6 |
| ENr334 | 41799445 | chr6 |
| ENr334 | 41816045 | chr6 |
| ENr334 | 41824045 | chr6 |
| ENr334 | 41843345 | chr6 |

### REFERENCES

1. Maston G A, Evans S K, Green M R (2006) Transcriptional Regulatory Elements in the Human Genome. Annu Rev Genomics Hum Genet 7: 29-59.
2. Butler J E, Kadonaga J T (2002) The RNA polymerase II core promoter: a key component in the regulation of gene expression. Genes Dev 16: 2583-2592.
3. Lee T I, Young R A (2000) Transcription of eukaryotic protein-coding genes Annu Rev Genet 34: 77-137.
4. Glass C K, Rosenfeld M G (2000) The coregulator exchange in transcriptional functions of nuclear receptors. Genes Dev 14: 121-141.
5. Tjian R, Maniatis T (1994) Transcriptional activation: a complex puzzle with few easy pieces. Cell 77: 5-8.
6. Zhang Y, Reinberg D (2001) Transcription regulation by histone methylation: interplay between different covalent modifications of the core histone tails. Genes Dev 15: 2343-2360.
7. West A G, Gaszner M, Felsenfeld G (2002) Insulators: many functions, many mechanisms. Genes Dev 16: 271-288.
8. ENCODE Project Consortium (2007) Identification and analysis of functional elements in 1% of the human genome by the ENCODE pilot project. Nature 447: 799-816.
9. Smith A D, Sumazin P, Zhang M Q (2005) Identifying tissue-selective transcription factor binding sites in vertebrate promoters. Proc Natl Acad Sci U S A 102: 1560-1565.
10. Smith A D, Sumazin P, Xuan Z, Zhang M Q (2006) DNA motifs in human and mouse proximal promoters predict tissue-specific expression. Proc Natl Acad Sci U S A 103: 6275-6280.
11. Cooper S J, Trinklein N D, Anton E D, Nguyen L, Myers R M (2006) Comprehensive analysis of transcriptional promoter structure and function in 1% of the human genome. Genome Res 16: 1-10.
12. Atchison M L (1988) Enhancers: mechanisms of action and cell specificity. Annu Rev Cell Biol 4: 127-153.
13. de Laat W, Grosveld F (2003) Spatial organization of gene expression: the active chromatin hub. Chromosome Res 11: 447-459.
14. Carey M (1998) The enhanceosome and transcriptional synergy. Cell 92: 5-8.
15. Blackwood E M, Kadonaga J T (1998) Going the distance: a current view of enhancer action. Science 281: 60-63.
16. Carter D, Chakalova L, Osborne C S, Dai Y F, Fraser P (2002) Long-range chromatin regulatory interactions in vivo. Nat Genet 32: 623-626.
17. Hatzis P, Talianidis I (2002) Dynamics of enhancer-promoter communication during differentiation-induced gene activation. Mol Cell 10: 1467-1477.
18. West A G, Fraser P (2005) Remote control of gene transcription. Hum Mol Genet 14 Spec No 1: R101-111.
19. Wijgerde M, Grosveld F, Fraser P (1995) Transcription complex stability and chromatin dynamics in vivo. Nature 377: 209-213.
20. Claessens F, Gewirth D T (2004) DNA recognition by nuclear receptors. Essays Biochem 40: 59-72.
21. Massari M E, Murre C (2000) Helix-loop-helix proteins: regulators of transcription in eucaryotic organisms. Mol Cell Biol 20: 429-440.
22. Pabo C O, Sauer R T (1992) Transcription factors: structural families and principles of DNA recognition. Annu Rev Biochem 61: 1053-1095.
23. Geyer P K, Spana C, Corces V G (1986) On the molecular mechanism of gypsy-induced mutations at the yellow locus of Drosophila melanogaster. Embo J 5: 2657-2662.
24. Chung J H, Whiteley M, Felsenfeld G (1993) A 5′ element of the chicken beta-globin domain serves as an insulator in human erythroid cells and protects against position effect in Drosophila. Cell 74: 505-514.
25. Bell A C, West A G, Felsenfeld G (1999) The protein CTCF is required for the enhancer blocking activity of vertebrate insulators. Cell 98: 387-396.
26. Gaszner M, Felsenfeld G (2006) Insulators: exploiting transcriptional and epigenetic mechanisms. Nat Rev Genet 7: 703-713.
27. Gerasimova T I, Byrd K, Corces V G (2000) A chromatin insulator determines the nuclear localization of DNA. Mol Cell 6: 1025-1035.
28. Yusufzai T M, Tagami H, Nakatani Y, Felsenfeld G (2004) CTCF tethers an insulator to subnuclear sites, suggesting shared insulator mechanisms across species. Mol Cell 13: 291-298.
29. Valenzuela L, Kamakaka R T (2006) Chromatin insulators. Annu Rev Genet 40: 107-138.
30. Heintzman N D, Stuart R K, Hon G, Fu Y, Ching C W, et al. (2007) Distinct and predictive chromatin signatures of transcriptional promoters and enhancers in the human genome. Nat Genet 39: 311-318.
31. ENCODE_Consortium (2004) The ENCODE (ENCyclopedia Of DNA Elements) Project. Science 306: 636-640.
32. Agalioti T, Lomvardas S, Parekh B, Yie J, Maniatis T, et al. (2000) Ordered recruitment of chromatin modifying and general transcription factors to the IFN-beta promoter. Cell 103: 667-678.
33. Chi T (2004) A BAF-centred view of the immune system. Nat Rev Immunol 4: 965-977.
34. Pokholok D K, Harbison C T, Levine S, Cole M, Hannett N M, et al. (2005) Genome-wide map of nucleosome acetylation and methylation in yeast. Cell 122: 517-527.
35. Liu C L, Kaplan T, Kim M, Buratowski S, Schreiber S L, et al. (2005) Single-nucleosome mapping of histone modifications in S. cerevisiae. PLoS Biol 3: e328.
36. Koch C M, Andrews R M, Flicek P, Dillon S C, Karaoz U, et al. (2007) The landscape of histone modifications across 1% of the human genome in five human cell lines. Genome Res 17: 691-707.
37. Denoeud F, Kapranov P, Ucla C, Frankish A, Castelo R, et al. (2007) Prominent use of distal 5′ transcription start sites and discovery of a large number of additional exons in ENCODE regions. Genome Res. 17: 746-759.
38. Wei G H, Liu D P, Liang C C (2005) Chromatin domain boundaries: insulators and beyond. Cell Res 15: 292-300.
39. Kim T H, Abdullaev Z K, Smith A D, Ching K A, Loukinov D I, et al. (2007) Analysis of the vertebrate insulator protein CTCF-binding sites in the human genome. Cell 128: 1231-1245.
40. Zheng M, Barrera L O, Ren B, Wu Y N (2007) ChIP-chip: Data, Model, and Analysis. Biometrics 63(3): 787-796.
41. Xi H, Shulha H P, Lin J M, Vales T R, Fu Y, et al. (2007) Identification and characterization of cell type-specific and ubiquitous chromatin regulatory structures in the human genome. PLoS Genet 3: e136.
42. Boyer L A, Lee T I, Cole M F, Johnstone S E, Levine S S, et al. (2005) Core transcriptional regulating circuitry in human embryonic stem cells. Cell 122: 947-956.
43. Berman B P, Nibu Y, Pfeiffer B D, Tomancak P, Celniker S E, et al. (2002) Exploiting transcription factor binding site clustering to identify cis-regulatory modules involved in pattern formation in the Drosophila genome. Proc Natl Acad Sci U S A 99: 757-762.
44. Lander E S, Linton E M, Birren B, Nusbaum C, Zody M C, et al. (2001) Initial sequencing and analysis of the human genome. Nature 409: 860-921.
45. Ludwig T E, Bergendahl V, Levenstein M E, Yu J, Probasco M D, et al. (2006) Feeder-independent culture of human embryonic stem cells. Nat Methods 3: 637-646.
46. Wu Z, Irizarry R, Gentleman R, Martinez-Murillo F, Spencer F (2004) A Model-Based Background Adjustment for Oligonucleotide Expression Arrays. Journal of the American Statistical Association 99: 909-917.
47. Kim T H, Barrera L O, Zheng M, Qu C, Singer M A, et al. (2005) A high-resolution map of active promoters in the human genome. Nature 436: 876-880.
48. Jothi R, Cuddapah S, Barski A, Cui K, Zhao K (2008) Genome-wide identification of in vivo protein-DNA binding sites from ChIP-Seq data. Nucleic Acids Res 36: 5221-5231.
49. Barski A, Cuddapah S, Cui K, Roh T-Y, Schones D E, Wang Z, Wei G, Chepelev I, Zhao K (2007) High-resolution profiling of histone methylations in the human genome. Cell 129: 823-837.

### Figure Legends

FIG. 1: Chromatin acetylation features at promoters and enhancers. ChIP-chip was performed on the acetylated histones H3K9Ac, H3K18Ac, and H3K27Ac, and the enrichment was compared to the (a) promoter and (b) p300 clusters from Heintzman et al in HeLa cells [30]. Each horizontal line details the ChIP-chip enrichment of various chromatin modifications and transcription factors in 10 kb windows. For consistency in comparison, we clustered the data in the same order as Heintzman et al. [30], who used k-means clustering. All three active promoter clusters P2, P3, and P4 are highly enriched in all three acetylated histones, whereas the enhancer clusters are mostly enriched in H3K18Ac and H3K27Ac, but have only weak H3K9Ac enrichment. Average profiles of log enrichment ratios for promoters or p300 binding sites in each cluster are shown at the bottom of each panel.

FIG. 2: Chromatin modifications at Gencode TSSs are generally invariant across 5 cell types. We performed computational clustering using H3K4Me1, H3K4Me3, H3K27Ac, and TAF1 for all five cell types, with 10 kb windows centered at Gencode TSSs (k-means clustering, k=4). In each of the four clusters, the enrichment pattern of chromatin modifications is largely invariant across cell types. Average profiles for each cluster are shown in the bottom panel.

FIG. 3: CTCF binding is invariant across cell types. We performed computational clustering on 729 consensus CTCF binding sites obtained by merging CTCF sites called by Mpeak for each of the five cell types (k-means clustering, k=4). The enrichment pattern of CTCF is generally invariant across cell types. For comparison, we also include ChIP-chip data from a genome-wide survey in IMR90 fibroblast cells [39]. Average profiles for each cluster are shown in the bottom panel.

FIG. 4: The localization pattern of the coactivator p300 is cell-type specific. We performed k-means clustering (k=3) on p300 binding sites obtained by merging p300 sites distal to Gencode TSS's from HeLa, GM, and K562. Unlike the patterns observed at Refseq TSSs and CTCF, the localization of p300 is cell-type dependent. Generally, TSS-distal p300 binding sites are marked by H3K4Me1 and H3K27Ac, but not H3K4Me3. Average profiles for each cluster are shown in the bottom panel.

FIG. 5: The localization pattern of predicted enhancers is cell-type specific. Using the approach from Heintzman et al. [30], we scanned H3K4Me1 and H3K4Me3 in the ENCODE regions to identify putative enhancers in all five cell types. We combined all the putative enhancers and computationally clustered the sites across all five cell types (k-means, k=6). Five of the six clusters show high cell-type specificity, while the sixth contains enhancers that are shared across multiple cell types. Average profiles for each cluster are shown in the bottom panel.

FIG. 6: Differential chromatin enrichment at promoters correlates with differential gene expression. For a given gene differentially expressed in 2 cell types, we computed the average enrichment in a 5-kb window centered at the promoter for each cell type for a given chromatin mark. We then plotted the differential expression as a function of the difference in chromatin enrichment for (a) H3K4Me3 (Pearson correlation coefficient c=0.7417,p=9.54E-06), (b) H3K18Ac (c=0.6876,p=7.41E-05), and (c) TAF1 (c=0.6803, p=9.45E-04).

FIG. 7: Enhancers are clustered at differentially expressed genes, and their effect on gene expression is synergistic. (a) To show that enhancers are clustered, we computed the distance between adjacent enhancers and examined the distribution of these distances. The distribution of adjacent enhancer-enhancer distances (red), as compared to 1000 sets of randomly placed sites (blue), indicates that enhancers are highly clustered. (b) A CTCF block is defined by flanking CTCF binding sites. Using the 729 consensus CTCF binding sites to define CTCF blocks, we counted the average number of enhancers found in blocks relative to the TSSs of differentially expressed and repressed genes. For a given TSS, CTCF block 0 is defined by the CTCF binding sites immediately flanking the TSS, CTCF block −1 is the block immediately upstream of CTCF block 0, CTCF block +1 is the block immediately downstream of CTCF block 0, etc. Differentially expressed genes are enriched in enhancers when compared to differentially repressed genes, with the strongest enrichment found in CTCF block 0.The dotted line indicates the expected average number of enhancers in a CTCF block. For HeLa, GM, and K562, differential expression was defined by an RMA p-value cutoff of 0.01 and a fold change cutoff of 2.0. (c) A detailed view of the distribution of enhancers in CTCF block 0. Here, we show the distribution of enhancer-TSS distances for all enhancers within this CTCF block. Negative distances indicate upstream enhancers, while positive distances indicate downstream enhancers. Enhancers are more concentrated to differentially expressed genes relative to differentially repressed genes. (d) To compare the concentration of enhancers at differentially expressed genes to that expected at random, we randomly placed 100 sets of enhancers and determined the average concentration of enhancers expected. Enhancers are more enriched at differentially expressed genes than would be expected for random distribution. Error bars indicate one standard deviation. (e) For each pair of cell types, we compared the change in enhancer counts within CTCF block 0 for differentially expressed genes with all other genes. The average gene not differentially expressed between a pair of cell types has a difference of −0.05 enhancers, as compared to 1.47 for differentially expressed genes. (f) We examined the effect of enhancer numbers on gene induction. For each TSS with expression data, we computed the difference in the number of enhancers in CTCF block 0, along with the difference in expression of the TSS's gene, for each pair of cell types. Each point is an average of 10 TSSs. The least-squares best fit line is indicated in blue (Pearson correlation coefficient=0.689). Error bars indicate one standard deviation. (b-e) To avoid double-counting, an enhancer can be counted at most once per comparison of 2 cell types. (b-f) Only HeLa, GM, and K562 cell types are considered.

FIG. 8: Summary of ChIP-chip and expression experiments. The number of biological replicates for each cell-type is given.

FIG. 9: Verification of histone modification-based prediction of enhancers. (a-d) The percentage of predicted enhancers within 2.5 kb of hypersensitive sites in HeLa, GM, K562, and ES cells as defined in Xi et al [41]. (e-g) The percentage of p300 sites mapped in HeLa, GM, and K562 cell lines within 2.5 kb of predicted enhancers. Random is defined by 100 random sets of sites of the same size as the predicted enhancer sets, where sampling is restricted to regions on the NimbleGen ENCODE array. The error bars indicate 1 standard deviation.

FIG. 10: Predicted ES enhancers are enriched in known ES-specific transcription factors. The number of enhancer predictions within 2.5 kb to known NANOG, OCT4, and SOX2 binding sites is indicated.

FIG. 11: Examples of differentially expressed and repressed genes having similar or different histone modifications at promoters. (a) A cluster centered at genes differentially upregulated in HeLa cells, as compared to GM cells. Note the differences in promoter chromatin modifications. (b) As in (a), but upregulated in K562 cells, as compared to HeLa cells. Note the similarity in promoter chromatin modifications. The percentage of the genes that are called Present (actively expressed) by Affymetrix expression arrays is indicated at right.

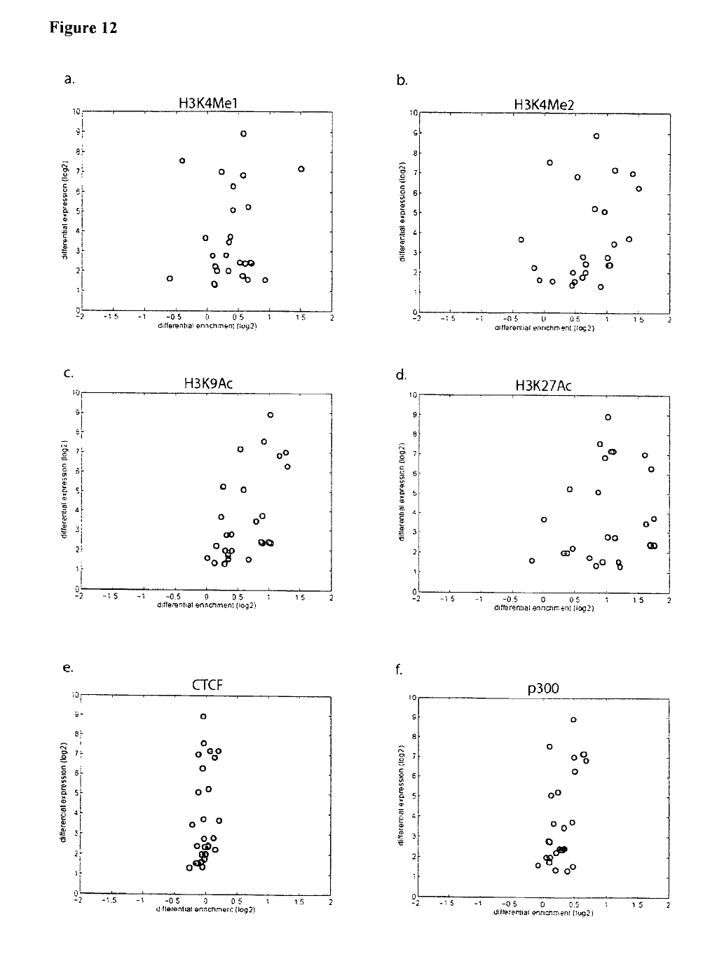

FIG. 12: Shown are the relationships of differential chromatin enrichment to differential gene expression for (a) H3K4Me1 (Pearson correlation coefficient=0.2653, p=0.181), (b) H3K4Me2 (corr=0.3385,p=0.0841), (c) H3K9Ac (corr=0.5367,p=(d) H3K27Ac (corr=0.1318, p=0.5123), (e) CTCF (corr=0.2605, p=0.1894), and (f) p300 (corr=0.5086,p=0.0067).

FIG. 13: Shown are (a) The distribution of adjacent TSS-TSS distances (gray) for Gencode TSSs, as compared to a random placement of sites (black) and (b) the distribution of adjacent CTCF-CTCF distances (gray), as compared to a random placement of sites (black).

FIG. 14: (a) Rather than examining the distribution of all enhancer-TSS distances in a differentially expressed/repressed gene's CTCF block (FIG. 7c), we examined only the closest one here. While we did observe enrichment in differentially expressed genes, the effect was smaller than that observed when we considered all enhancer-TSS distances. (b) This depicts the results of analysis as in FIG. 7f, but only considering differentially expressed genes (Pearson correlation coefficient=0.749).

FIG. 15: The same analysis is shown as shown in FIG. 7, but using TSS-distal p300 sites rather than enhancers.

### Table Captions

Table 1: ChIP-chip enrichment values across different cell types are much more highly correlated at Gencode promoters and CTCF binding sites than at p300 binding sites and predicted enhancers.

Table 2: Predicted enhancers in HeLa. The first column is the ENCODE region, the second column is the hg17 chromosomal coordinate of the predicted enhancer, and the third column indicates the chromosome where the enhancer is found.

Table 3: Predicted enhancers in GM. The first column is the ENCODE region, the second column is the hg17 chromosomal coordinate of the predicted enhancer, and the third column indicates the chromosome where the enhancer is found.

Table 4: Predicted enhancers in K562. The first column is the ENCODE region, the second column is the hg17 chromosomal coordinate of the predicted enhancer, and the third column indicates the chromosome where the enhancer is found.

Table 5: Predicted enhancers in ES. The first column is the ENCODE region, the second column is the hg17 chromosomal coordinate of the predicted enhancer, and the third column indicates the chromosome where the enhancer is found.

Table 6: Predicted enhancers in dES. The first column is the ENCODE region, the second column is the hg17 chromosomal coordinate of the predicted enhancer, and the third column indicates the chromosome where the enhancer is found.

What is claimed is:

1. A method for finding enhancer elements in a genome segment, comprising the steps of:
a) determining the chromatin signatures present in the segment;
b) analyzing the signatures found for features determined to be characteristic of enhancer elements; and
c) identifying as enhancer elements those portions of the analyzed segment that contain said features.

2. The method according to claim 1 wherein step a) is performed using CUP-chip or ChiP-Seq analysis.

3. A diagnostic method for cancer and other diseases in a patient, comprising the steps of:
a) obtaining chromatin from a tissue, blood or plasma sample, or from a cell line, from the patient;
b) determining the signatures present in the chromatin; and
c) in the case wherein the quantity of chromatin signatures at a subset of enhancers associated with cancerous cells or with cells that are known to be present in association with another disease state is above a set threshold, identifying the patient as likely having the cancer or other disease state.

4. A prognostic method for cancer or another disease state in a patient known already to have such a condition, comprising the steps of:
a) obtaining chromatin from a tissue, blood or plasma sample, or from a cell line, from the patient;
b) determining the quantity and distribution of enhancers in the chromatin that are associated with the cancer or other condition; and
c) using the results of the determination in step b) as a basis for assessing the optimal treatment regimen for the patient, for predicting the patient's response to the treatment and for predicting the likelihood or duration of survival of the patient.

5. A method for monitoring the progress of treatment of a patient having cancer or another disease state, comprising the steps of:
a) obtaining, both before and after treatment, chromatin from a tissue, blood or plasma sample, or from a cell line, from the patient;
b) determining the change from before the treatment in quantity and distribution of nhancers in the chromatin that are associated with the cancer or other condition; and
c) using the results of the determination in step b) to 1) assess the effectiveness of the treatment regimen; 2) assess the need for any adjustments in said regimen; and 3) identify the specifics of any such adjustments.

6. A method for the identification of differentially expressed and differentially repressed genes in a genome segment from a particular cell type of a host, which comprises employing the method according to claim 1 followed by the further steps of:
d) analyzing the distribution of the enhancers using computational clustering analysis;
e) identifying those regions of the analyzed genome segment having enrichment and clustering of enhancers as containing a differentially expressed gene or genes; and
f) identifying those regions of the analyzed genome segment not having such enrichment and clustering as containing a differentially repressed gene or genes.
